(19) United States
(12) Patent Application Publication
(10) Pub. No.: US 2017/0140405 A1
(43) Pub. Date: May 18, 2017

(54) GLOBAL MARKET MODELING FOR ADVANCED MARKET INTELLIGENCE

(71) Applicants: Chakradhar Gottemukkala, Austin, TX (US); Ijaz Husain Parpia, Southlake, TX (US)

(72) Inventors: Chakradhar Gottemukkala, Austin, TX (US); Ijaz Husain Parpia, Southlake, TX (US)

(73) Assignee: O9 Solutions, Inc.

(21) Appl. No.: 13/410,222

(22) Filed: Mar. 1, 2012

(51) Int. Cl. G06Q 30/02

(52) U.S. Cl. CPC G06Q 30/0206

(57) ABSTRACT

A global market model models aspects of the global marketplace and provides models of market segments, value chains of those market segments, organizations, products, and other aspects of the global marketplace. Requests for market intelligence of a global market model are received and can include, in some instances, market intelligence relating to competitors, suppliers, channel partners, market size, market share, market share drivers, and demand changes within the global marketplace. Parameters of the requests are identified and used to identify business logic responsive to the request. One or more model instances of the global market model are identified from the parameters. The identified business logic is applied to the identified model instances to generate a response to the request. In some instances, business logic can be embodied in a plurality of query modules and identifying responsive business logic can include invoking a corresponding one of the plurality of query modules.

### BACKGROUND

Modern enterprises are competing in global markets that are increasingly complex and dynamic. Globalization has expanded the universe of suppliers, competitors, channel partners, and customers with which an enterprise interacts, directly or indirectly, in the course of their business. These increasingly competitive markets can make even small competitive advantages yield large dividends in terms of financial performance.

Systems and services have been developed to assist market participants (enterprises, investors, etc.) in gathering intelligence relating to the global marketplace. Some systems and services provide access to market information on a subscription basis, such as Barron's™ and Standard & Poor's™, or according to other non-subscription business models, such as finance-related web-applications of Google™ and Yahoo™

### BRIEF DESCRIPTION OF DRAWINGS

FIG. 1 is a simplified schematic diagram of an example computing system adapted to provide an example global market model;

FIG. 2 is a simplified block diagram of an example system including an example global market intelligence engine;

FIG. 3A is a simplified block diagram representing principles of an example global market model;

FIG. 3B is a simplified block diagram of an example global market model;

FIGS. 4A-4F are simplified block diagrams illustrating example models used in queries within one example implementation of a global market model;

FIG. 4G is a simplified block diagram illustrating example relations between example model types in one example implementation of a global market model;

FIGS. 5A-51 are simplified representations of relations between market entities modeled by models of an example implementation of a global market model;

FIG. 6A-6C are simplified block diagrams illustrating example business scenarios capable of being modeled in an example global market model;

FIG. 6D is an example product comparison capable of being modeled in one example of a global market model;

FIGS. 7A-7H are screenshots of example user interfaces for use in connection with an example global market model;

FIGS. 8A-8B are flowcharts of example techniques for using an example global market model in accordance with at least some embodiments.

Like reference numbers and designations in the various drawings indicate like elements.

### SUMMARY

In general, one aspect of the subject matter described in this specification can be embodied in methods that include the actions of receiving a request for market intelligence embodied in a global market model, identifying parameters of the request, identifying particular business logic responsive to the request from a set of business logic, and identifying one or more models of the global market model from the parameters of the request, the global market model including a plurality of models, each model modeling aspects of a global marketplace. The particular business logic can be applied to the identified one or more models to return a response to the request.

Further, in another general aspect, a system can be provided including at least one processor device, at least one memory element, and a global market intelligence engine. The global market intelligence engine, when executed by the processor, can receive a request for market intelligence of a global market model, identify parameters of the request, identify particular business logic responsive to the request from a set of business logic, and identify one or more models of the global market model from the parameters of the request, the global market model including a plurality of models, each model modeling aspects of a global marketplace. The particular business logic can be applied to the identified one or more models to return a response to the request.

Further, in yet another general aspect, a computer program product can be provided that is encoded on a tangible, non-transitory, machine readable storage medium, the product including a global market software model and program code. The global market software model can include a market product category model type, a market region model type, an organization model type, a customer segment model type, a value chain model type, and a market segment model type. The program code can be operable, when executed by a processor, to generate instances of the model types of the global market software model and respond to received requests for market intelligence based on the global market software model using business logic from a set of business logic.

These and other embodiments can each optionally include one or more of the following features. The one or more models can be identified using the identified particular business logic. The one or more models can be instances of model types in a plurality of available model types in the global market model, the plurality of available model types including at least a market product category model type, a market region model type, an organization model type, a customer segment model type, a value chain role model type, and a market segment model type. It can be identified that the request relates to a particular category of information provided by the global market model and a particular one of a plurality of query modules can be identified as including business logic adapted to respond to requests relating to the particular category of information. The business logic of the particular query can be applied against model instances of the global market model to generate the response. For instance, the request can invoke such query modules as a channel partners query module adapted to identify organizations that are channel partners to a particular organization in a particular market segment, a value chain suppliers query module adapted to identify organizations that are suppliers to a particular organization in a particular market product category, a product category competitors query module adapted to identify organizations that are competitors of one another in a particular market product category based on respective value chain roles of the organizations, and/or an organization competitors query module adapted to identify organizations that are competitors of a particular organization in a particular market segment. In some instances, the request can cause the invocation of other (or additional) query modules such as a competitive landscape query module adapted to identify products that compete with one another in a particular market segment, and a product competition query module adapted to identify products that compete with a particular product in one or more particular market product categories. The request can further cause invocation of other (or additional) query modules such as a market size forecast query module adapted to return a market size forecast of a particular market segment corresponding to a particular time period, a demand change query module adapted to identify organizations impacted by a particular change in demand within the value chain, a share-winning products query module adapted to identify products within a particular market segment enjoying highest market share within the particular market segment, a share drivers ranking query module adapted to identify a rank-ordered listing of share drivers influencing market share within the particular market segment, and/or a share driver comparison query module adapted to identify values of share drivers of competing products within the particular market segment.

Further, embodiments can each optionally include one or more of the following features. The response can be returned by sending response data, via an application programming interface (API), to a client program hosted on a remote computing device. Returning the response can also, or alternatively, include causing response data to be rendered in a graphical user interface (GUI) presentation on a client device. The request can be translated into a structured expression including an identification of at least one model type and at least one filter expression, the parameters including the at least one model type and at least one filter expression. The request can be a natural language query and identifying parameters of the request can include interpreting the natural language query. The set of business logic can be utilized by a plurality of query modules, each query module adapted to return responses to a corresponding category of queries of the global market model. Identifying the particular business logic can include identifying a particular one of the plurality of query modules corresponding to the request. Indeed, a query library can be provided, the query library including a plurality of queries that include at least two or more of the following: a channel partners query module comprising business logic adapted to provide responses to requests concerning the identification of channel partners within modeled value chains, a product category competitors query module comprising business logic adapted to generate responses to requests concerning the identification of competitors within modeled value chains of a product category, a value chain suppliers query module comprising business logic adapted to generate responses to requests concerning suppliers in modeled value chains, a demand change query module comprising business logic adapted to generate responses to requests concerning propagation within modeled value chains, a competitive landscape query module comprising business logic adapted to generate responses to requests concerning competing products in modeled product markets, a product competition query module comprising business logic adapted to generate responses to requests relating to features of competing products in modeled product markets, a market size forecast query module comprising business logic adapted to generate responses to requests concerning forecasted size of a market segment, a share drivers query module comprising business logic adapted to generate responses to requests concerning leading drivers of market share within a market segment, an organizations query module comprising business logic adapted to generate responses to requests concerning organizations modeled in the global market software model, a customer segments query module comprising business logic adapted to generate responses to requests concerning customer segments of a product category, a product categories query module comprising business logic adapted to generate responses to requests concerning product categories modeled in the global market software model, a market regions query module comprising business logic adapted to generate responses to requests concerning geographic market regions modeled in the global market software model, a people query module comprising business logic adapted to generate responses to requests concerning persons modeled in the global market software model, a forecasted segments query module comprising business logic adapted to generate responses to requests concerning adapted to identify a listing of markets segments for a particular market product category involved in a particular market forecast of the market product category, an organization competitors query module comprising business logic adapted to generate responses to requests concerning competitors of an organization, a competitor categories query module comprising business logic adapted to generate responses to requests concerning competing product categories, a share-winning products query module comprising business logic adapted to generate responses to requests concerning market share of products within a market segment, a share drivers ranking query module comprising business logic adapted to generate responses to requests concerning the share drivers with highest influence on market share within a market segment, and a share driver comparison query module comprising business logic adapted to generate responses to requests concerning the values of respective share drivers of products within a market segment.

Further, embodiments can each optionally include one or more of the following features. Instances of the market product category model type can each model a respective market product category and include instances of: a sub-category model type modeling subcategories of the respective market product category modeled by the corresponding instance of the market product category model and a product category feature model type modeling a set of product features for the respective market product category. Instances of the market product category model type can further include instances of a category component model type modeling relationships of the respective market product category with one or more other market product categories identified as sub-components of the respective market product category, a category substitute model type modeling relationships of the respective market product category with one or more other market product categories identified as potential substitute market product categories of the respective market product category, and an accessory model type modeling relationships of the respective market product category with one or more other market product categories identified as accessories of the respective market product category. Instances of the market region model type can each model a respective geographic market region and include at least one instance of a sub-region model type modeling a sub-region of the respective geographic market region modeled by the respective instance of the market region model type. Instances of the organization model type can each model a respective market participant and include instances of a product model type modeling products offered by the market participant modeled by the corresponding instance of the organization model type, a product group model type modeling groupings of products offered by the market participant modeled by the corresponding instance of the organization model type, a supply chain activity model type modeling activities and lead times of activities performed by the market participant modeled by the corresponding instance of the organization model type, an inventory node model type modeling inventory policy of the market participant modeled by the corresponding instance of the organization model type, and a facility model type modeling facilities of the market participant modeled by the corresponding instance of the organization model type. Instances of the market segment model type can each model a respective market segment and include instances of a market size forecast model modeling forecasts of the size of the market segment modeled by the corresponding instance of the market segment model type, a market share driver model type modeling market share drivers of the market segment modeled by the corresponding instance of the market segments model type, a market share driver forecast model type modeling forecasts of the relative importance of market share drivers of the market segment modeled by the corresponding instance of the market segment model type, and a market share forecast model type modeling forecasts of market share of products within the market segment modeled by the corresponding instance of the market segments model type. The global market model can further include a value chain role model type, each instance of the value chain role model type modeling respective roles that an organization can play within one or more market product categories. The global market model can further include a person model type, each instance of the person model type modeling respective persons within a market. A model generator can be provided that is adapted, when executed by the at least one processor device to collect data from one or more sources and prepare the collected data for use in generating instances of the one or more model types of the global market model. A query engine can be provided that is adapted, when executed by the at least one processor device to identify a particular query, from a plurality of available queries (such as from the query library), as responsive to the request, and apply the business logic of the particular query module to the one or more models to generate the response.

Some or all of the features may be computer-implemented methods or further included in respective systems or other devices for performing this described functionality. The details of these and other features, aspects, and implementations of the present disclosure are set forth in the accompanying drawings and the description below. Other features, objects, and advantages of the disclosure will be apparent from the description and drawings, and from the claims.

### DETAILED DESCRIPTION

Organizations compete against and/or partner with other organizations in serving the needs of a variety of market segments in the global marketplace. An organization's planning processes can aim to formulate strategy, investments, and corresponding products and services for the organization's participation within the market. Planning and strategy can include developing marketing, pricing, sales, and operational plans to achieve its goals in each market segment it competes in, as well as making tactical adjustments to these plans as conditions change. Effective planning processes can include use of intelligence about the size of opportunities within the market, the critical drivers of share and price based on customer purchasing criteria, the competitive intensity, competitor and channel partner positions in each market segment, etc. Furthermore, such intelligence can assist organizations in not only understanding what is happening in a market segment today, but can also assist in forecasting how the size of certain market opportunities, share drivers, and the competitive landscape is likely to evolve over future time periods, for instance, given intelligence concerning lead times in making and executing product, sales, marketing and operational decisions, etc. Additionally, such market intelligence can be used by investors who aim to maximize returns through better understanding the changing dynamics in each market segment of the global marketplace and evaluating the impacts on different organizations that are competing or partnering with each other in the marketplace.

While traditional systems and services can provide data and news about events in individual organizations and industry sectors within the global marketplace, they can be limited in their ability to translate ongoing changes and events into intelligent insights about the impact to substantially all the players in the global marketplace. As an example, if the market demand for high definition televisions of screen sizes >50″ is growing at a larger than expected rate in the USA market, which enterprises across the global value chain are likely to be impacted? If a particular organization takes a big hit in the market place because its products in a particular category are having quality issues, which competitors are likely to benefit? Which suppliers of that organization and in turn their suppliers in the whole value chain are going to be impacted, among other considerations?

A global market intelligence system can be provided capable of modeling all relevant market product categories, market regions, customer segments, organizations, and products, as well as the market segments and the network of relationships between these elements of the global market. A global market model can be hosted (i.e., in memory of one or more computing devices implementing global market intelligence system) and can be used by the market intelligence systems to provide users with insights into how changes in any segment of the global market place are going to impact the different players and guide enterprise and investor decision making.

In some example implementations, a global market intelligence system can leverage the wealth of Internet-based resources to collect and collate data about events in the global market place and build a software-implemented global market model modeling and describing the various organizations, products, product categories, regional markets, market activities, market share, and other attributes of global markets. The system can further utilize advanced software modeling and analytics techniques to respond to queries of the global market model and return market intelligence responsive to these queries. For instance, the system can use business logic to generate responses, from the global market model, to queries concerning a market value chain and its participants, market competition between organizations and products, market share, demand changes (both real and hypothetical), market size, and others. Additionally, client systems and models can interface with implementations of a global market intelligence and management system and/or the global market model itself and utilize data and business logic of the global market intelligence system to obtain and consume market intelligence modeled and provided through the global market model.

In some instances, a global market intelligence system can include an advanced market intelligence system that can be used by enterprise decision makers and investors in to gain insights into the market and improve their decision making. The software system can include numerous model types (sometimes also referred to herein as “models”) that serve as templates, or classes, for creating models, or instantiations of a respective model type. The instantiated models, collectively, can serve as a global market model to capture all of the critical elements of a global market and the interactions and relationships of entities within the marketplace. A global market model can include instantiations of model types including a market product category model type, a market region model type, an organization model type, a value chain role model type, a customer segment model type and a market segment model type. The organization model type additionally comprises several sub-model types: a product model type, a product group model type, a facility model type, an inventory node model type, a supply chain activity model type, among others. Additionally, each model type can include several sub-model types. For instance, a market segment model type can include such sub-model types as a market size forecast model type, a market share driver model type, a market share driver forecast model type, a market share forecast model type, among others.

Further, a query engine can be provided capable of processing requests for market intelligence from the global market model, or queries. Users can submit such queries to glean numerous insights into the market, including: opportunities by each segment of the market; competitive intensity and drivers of share in each market segment; how different organizations are connected as suppliers, customers, competitors and channel partners; how different organizations are impacted by changes in the market at both a macro and a micro level; among others. Insights gleaned by users, whether investors or enterprise users, can allow them to make better decisions.

I. Hardware Implementation of an Example Global Market Intelligence System

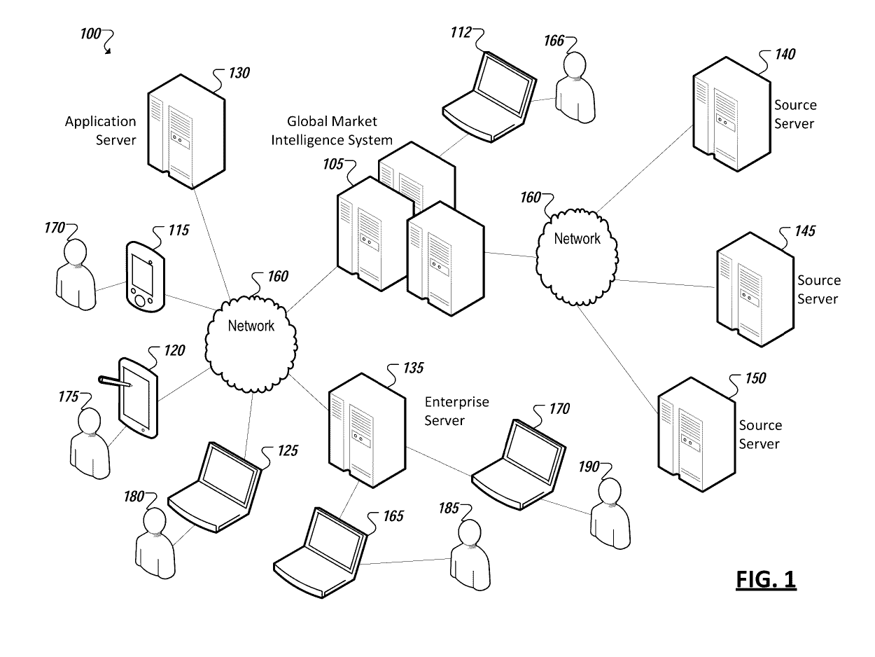

FIG. 1 is a simplified block diagram illustrating an example implementation of a computing system 100 including a global market intelligence system 105 capable of generating, maintaining, and serving a global market model including information and modeling attributes of a universe of known international markets for goods and services, including value chains and participants within these markets. System 100 can further include a plurality of computing devices (e.g., 112-150) each capable of interfacing and communicating with global market intelligence system 105, for instance, over one or more networks 160. Networks 160 can include public networks such as the Internet as well as private networks, including local area networks (LANs), wireless LANs (WiLANs), and the like.

Devices in the plurality of computing devices 112-150 can include user computing devices (e.g., 112) adapted for use in maintaining and supplying data for inclusion in a global market model maintained by global market intelligence system 105. For example, administrator users (e.g., 166) can perform tasks via user computing devices (e.g., 112) relating to quality control, model building, data entry, and model maintenance. In some instances, administrator users 166 can be affiliated with the organization managing, providing, or otherwise maintaining an example global market model and global market intelligence system 105. In other instances, third party users (e.g., 170, 175, 180) can also provide data and refine assumptions, data, and attributes of portions of the global market model using computing devices (e.g., 115, 120, 125). Additional user computing devices (e.g., 115, 120, 125) can further include client devices accessing, consuming, and otherwise using data provided by a global market model hosted by global market intelligence system 105. For instance, in some example implementations, global market intelligence system 105 can respond and provide answers, analytics, infographics, links, business intelligence, and other results in response to one or more user-provided questions or requests of the global market model. Third-party users, such as company managers and executives, market analysts, investors, students, and other users (e.g., 170, 175, 180) can thereby query the global market model to obtain tailored market intelligence for use within their various capacities and to guide decision-making and analytics relating to the global marketplace.

Consumers of a global market model hosted by global market intelligence system 105 can further include applications and other programs provided, for instance, by the developer or managing entity of the global market model or third parties. For instance, an application server 130 can interface with global market intelligence system 105 via one or more APIs to utilize data and/or services provided through global market model and served by global market intelligence system 105. Further, companies, enterprises, brokerages, market analysis firms, and other organizations, including those participating in the international markets modeled by a global market model can interface with and use the global market model to obtain market intelligence and supplement proprietary and enterprise-specific models and management systems utilized by the enterprise, for instance, in connection with the enterprise's efforts to realize certain goals. Additional computing devices (e.g., 165, 170) of the enterprise can utilize enterprise-specific models incorporating intelligence from and interfacing with the global market model. The enterprise's users (e.g., at 185, 190) can glean important business intelligence from the enterprise-specific models and management tools accessing and incorporating market intelligence gleaned from interactions with the global market model to thereby guide and assist the users (e.g., at 185, 190), and the enterprise, in making more-informed and, potentially, more-effective business decisions.

Global market intelligence system 105 can further interface with and access data provided by a plurality of source servers (e.g., 140, 145, 150) hosting data for inclusion and use in instantiating models of the global market model. Source servers (e.g., 140, 145, 150) can include servers of publicly-available, subscription-based, and otherwise accessible data describing attributes of enterprises, products, inventory, market share, regional markets, production cycles, market performance, supply chains, events, and other elements of international markets. For instance, a source server (e.g., 140, 145, 150) can include aggregators of business and market data, ecommerce websites, financial reporting websites, websites hosted by market participants, and other sources hosting product catalogs, governmental filings, financial statements, prospectuses, investor information, product instruction manuals, financial analyst reports, market news, and other information for use and inclusion in the global market model. In some instances, global market intelligence system 105 can automatically retrieve such data, for instance, to populate various data structures, including the inherent data and sub-models of the example global market model. In other instances, business data automatically collected by global market intelligence system 105 can be supplemented by human users interfacing with the global market intelligence system 105, for instance, using user computers (e.g., 112, 115, 120, 125, 165, 170), including computing devices local to and remote from global market intelligence system 105.

In general, “servers,” “clients,” and “computing devices,” including computing devices in example system 100 (e.g., 105-150, 165, 170, etc.), can include electronic computing devices operable to receive, transmit, process, store, or manage data and information associated with the software system 100. As used in this document, the term “computer,” “computing device,” “processor,” or “processing device” is intended to encompass any suitable processing device. For example, the system 100 may be implemented using computers other than servers, including server pools. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, and computing devices (e.g., 105-150, 165, 170) can each include one or more processors, computer-readable memory, and one or more interfaces, among other features and hardware. Servers can include any suitable software component or module, or computing device(s) capable of hosting and/or serving software applications and services (e.g., the global market model of global market intelligence system 105, services of application server 130, models and services of organization server 135, etc.), including distributed, enterprise, or cloud-based software applications, data, and services. For instance, servers can be configured to host, serve, or otherwise manage models and data structures, data sets, software service and applications interfacing, coordinating with, or dependent on or used by other services and devices. In some instances, a server, system, subsystem, or computing device can be implemented as some combination of devices that can be hosted on a common computing system, server, server pool, or cloud computing environment and share computing resources, including shared memory, processors, and interfaces.

User computing devices (e.g., 112, 115, 120, 125, 165, 170) can include traditional and mobile computing devices, including personal computers, laptop computers, tablet computers, smartphones, personal digital assistants, feature phones, handheld video game consoles, desktop computers, internet-enabled televisions, and other devices designed to interface with human users and capable of communicating with other devices over one or more networks (e.g., 160). Attributes of user computing devices, and computing device generally (e.g., 105-150, 165, 170), can vary widely from device to device, including the respective operating systems and collections of software programs loaded, installed, executed, operated, or otherwise accessible to each device. For instance, computing devices can run, execute, have installed, or otherwise include various sets of programs, including various combinations of operating systems, applications, plug-ins, applets, virtual machines, machine images, drivers, executable files, and other software-based programs capable of being run, executed, or otherwise used by the respective devices.

Some computing devices (e.g., 112, 115, 120, 125, 165, 170, etc.) can further include at least one graphical display device and user interfaces allowing a user to view and interact with graphical user interfaces of applications and other programs provided in system 100, including user interfaces and graphical representations of programs interacting with a global market model hosted by global market intelligence system 105. Moreover, while user computing devices (e.g., 112, 115, 120, 125, 165, 170) may be described in terms of being used by one user, this disclosure contemplates that many users may use one computer or that one user may use multiple computers.

While FIG. 1 is described as containing or being associated with a plurality of elements, not all elements illustrated within system 100 of FIG. 1 may be utilized in each alternative implementation of the present disclosure. Additionally, one or more of the elements described in connection with the examples of FIG. 1 may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

II. Example Modules and Functionality of a Global Market Intelligence System

Turning to FIG. 2, a simplified block diagram is shown of an example system 200 including an example global market intelligence engine 205. In some instances, global market intelligence engine 205 can be hosted by a global market intelligence system, such as the global market intelligence system described in the example of FIG. 1. Global market intelligence engine 205 can host, serve, maintain, or otherwise provide an example global market model. System 200 can further include one or more additional computing devices, systems, and software-based tools (e.g., 215, 220, 225, 230, 235) communicating with global market intelligence engine 205, for instance, over one or more networks (e.g., 240).

An example global market intelligence engine 205 can include one or more processors 245 and memory elements 248, as well as one or more software- and hardware-implemented components and tools embodying functionality of the global market intelligence engine 205. In some examples, a global market intelligence engine 205 can include or be conceptualized as a multi-layered software system such as shown in the particular example of FIG. 2. An example system layer architecture of an example global market intelligence engine 205 can include, for instance, a data collection layer 270, model layer 275, queries layer 280, and user interface layer 285, among potentially other layers.

An example data collection layer 270 can include functionality for identifying, collecting, capturing, and scrubbing data from potentially millions of public sources, such as Internet-based market information sources, for use with the global market model. For instance, an example data collection layer 270 can include logic and functionality enabling user programmers, including third-party users, to develop model types, sub-model types, instantiations of the model types, query modules, and other data structures and logic for inclusion in the global market model as well as edit and provide feedback for existing structures of the global market model. Further, an example data collection layer 270 can further include logic and functionality enabling data to be collected to populate the global market model and model fields and attributes to be defined for model instances of global market model. For instance, the data collection layer 270 can provide tools including logic and user interfaces for use by one or more users in connection with one or more users providing market data, entering data, defining market attributes for various model instances or data structures of the global market model, and performing quality control and other administrative tasks on the global market model and its data (e.g., in response to feedback received from customers and in connection with the global market model's development and construction).

Further, an example data collection layer 270 can further provide automated model building and maintenance tools, such as a crawler or other tools configured to scan and collect digital resources including webpages, catalogs, electronic documents, files, databases, and other resources hosted, for instance, by source servers 215, to identify data relevant to fields, attributes, and sub-models of the global market model. For example, a crawler can identify, for instance, financial statements, 10K and other government filings, company profiles, online catalogs, investment analyses, and other online digital resources and further automatically identify and collect information included in these resources that correspond to particular attributes of the global market model or otherwise relate to entities modeled by the global market model. For instance, a crawler or other data collection layer tool can be used to identify and collect any data describing particular companies and organizations in international markets, organizations' participation and performance is various product and service markets, organizations' participation and performance in various regional markets, upstream and downstream channel partners of various organizations, product categories, defined customer segments, market news, market performance data (e.g., stock quotes, earnings reports and forecasts, etc.), and so on. Further, a crawler or other data collection layer tool can identify changes and updates to data previously collected for the global market model and collect updated data for the global market model.

Market data collected by or through user-based sources or automated model-building tools, such as a crawler or other automated data collection tool, may need to be reformatted, normalized, or otherwise processed for use by or inclusion in the global market model. An example data scrubber tool (or other data collection layer tool) can be provided to supply such processing functionality. A data scrubber can include logic for intelligently scanning digital resources and data returned by data collection layer tools to identify, collect, reformat, and otherwise ready the data for inclusion in, compatibility and use with global market model. For instance, PDF documents discovered, such as a 10K or financial statement of an enterprise can be processed to identify particular data communicating information desired for inclusion in certain fields of data structures of the global market model, such as a particular balance sheet value, market share value, product price, website address, or other values or content defining particular attributes for the enterprise and its participation in international markets. In another example, data scrubber, or other data preparation tools of the data collection layer, can process a digital product catalog collected, for instance, by crawler and identify values corresponding to particular, defined product features, and further format the data to be consistent with other values for the product feature. For example, a data scrubber can identify that a collected digital resource describes a digital camera and can identify a value within the catalog pertaining to the resolution specifications for the digital camera. For instance, a data scrubber can identify that values in the format “##.#MP,” “##.# megapixels,” etc. likely correspond to a megapixel resolution value for the digital camera. Upon identifying data within the resource that satisfies this format, the data scrubber can pull the corresponding data values and populate corresponding fields and/or attributes of a particular model type instance of the global market model (e.g., a product model type instance modeling the particular digital camera described in the collected digital resource). Similarly, data scrubber can process the remainder of the digital resource in this example to identify, capture, and format additional data describing additional attributes of the described digital camera (e.g., other technical specifications, price, model number, etc.), enterprises associated with the digital camera, among other information usable in the global market model.

An example model layer 275 can include the global market model itself, along with logic and software tools for building, maintaining, populating, and defining the constituent data structures (e.g., instantiations of a plurality of available model types) of the global market model, as well as instantiating data structures of the global market model with data collected using data collection layer 270. An example global market model can include a collection of model instances, data objects, and other data structures for managing or structuring internal or inherent data of the global market model. The global market model can also include a plurality of models for modeling participants, products, and activities within a product or service market value chain including models, objects, and other data structures modeling, representing, and/or including data describing various business entities, market conditions, products, market transformation activities, and other features of a particular market's value chain. A model (or “model instance,” “instance of a model type,” “sub-model,” etc. used herein interchangeably) can include the global market model itself as well as any constituent sub-models of the global market model. A model can be a data structure (or a collection of data structures) having a defined internal structure configured to represent market information in model attributes and define dependencies, links, and other relationships between model attributes, sub-models, and other models (i.e., in accordance with the modeling of real-world market relationships and dependencies). The structure of a model can be based on (i.e., instantiated from) one of a plurality of various model types, or classes, the instances of the model type inheriting attributes, fields, structure, and hierarchy (e.g., sub-model types) of the respective model type. Further, a model (and its corresponding model type), in some instances, can be a multi-layered data structure or object, including layers such as a kernel layer (including the model's inherent data, such as collected data collection layer 270), data access layer (for accessing and utilizing the inherent data), interface layer (for providing interfaces to other models, programs, or components accessing and using the model, such as through queries layer 280), and logic layer (providing at least a portion of the logic used to process information included in instantiations of global market model model types to provide market intelligence results to consumers of the global market model, e.g., in connection with the tools and functionality of queries layer 280), among potentially other examples.

An example model layer 275 can further include logic and functionality adapted to be used in generating or otherwise accessing or identifying particular instantiations of the global market model or, put differently, instantiations of the constituent model types available in the global market model. In some instances, model instances of the global market model (e.g., of multiple model types) can be generated in advance of, or concurrently in connection with a particular task or query performed by components, programs, clients, and other systems interfacing with and using the global market model (such as functionality of queries layer 280. Ideally, a global market model includes data and structure allowing instances of at least portions of global market model to be generated and provided for any organization, market, market region, product category, customer segment, value chain role, or product known to exist within the global marketplace. Tools of the model layer 275 can utilize data collected by the data collection layer 270 to populate instances of particular model types consistent with the attributes, fields, and sub-models of the model type. A model type (also referred to herein, generically, as a “model”) can define the semantics, structure, fields, and attributes of a category of models. Fields can define model attributes (e.g., attribute values), as well as relationships, links, or pointers between multiple models (or, generally, between model types).

As an example, global market model can include a constituent value chain role model type, the instances of the example value chain role model type modeling the value chains of various (or all) international product and services markets, as well as the roles of various enterprises within these markets. Instantiations of the value chain role model(s) can be generated using the model layer 275 to model an individual market, value chain participants, product or service category, product, etc. Accordingly, a software representation of the corresponding value chain roles of a particular named organization, product category, etc. can be generated from an instance of a value chain role model type class. For instance, for an organization, a corresponding instantiation of the value chain role model can identify the various value chain roles known to be associated with the organization within the various markets in which the organization participates. For a named product or service category, a value chain role model can be instantiated showing the various value chain roles known to be included within the typical value chain of the named product or service, as well as, in some instances, the identification of organizations known to participate in one or more of the identified value chain roles of the product or service, as one example. In general, such model types can each provide the semantics, extensions, and structure for modeling a particular type of market entity, such as an organization, product category, market segment, product, person, etc., and instances (or “models”) of these respective model types can inherit the structure of the model class to model and represent a specific organization, product category, market segment, product, person, etc.

Some model types can include a hierarchical structure. A hierarchy can define a parent/child relationship between models of the same model type, where each model may have at most one parent, and may have zero, one or more children. A model with no parent is referred to as a “root” and a model with no children is referred to as a “leaf”. Hierarchies are useful for attribute inheritance, where an attribute is given a value for the parent and the same value is inherited by the children, unless explicitly overridden with a value set at the child. Hierarchies are also useful for aggregation and disaggregation of data related to the model type. For example, a value may be set at all of the leaf models, with the value at the parent models defined as the sum of the values of all of the children. Model types that allow for arrangement into hierarchies are not restricted to a single hierarchy definition, but may have multiple alternate hierarchies. This allows, for example, for a market region representing a state to have children that represent counties in one hierarchy, and in another hierarchy to have children that represent zip codes, among other examples.

Queries layer 280 can include a library of queries and business logic that can be applied against the relationships and models defined in the global market model representing circumstances, relationships, and activities within the global marketplace. Further, queries layer 280 can include logic for interpreting user queries and translating them into machine-actionable requests for market intelligence using business logic applied against the global market model. In some instances, the library of query modules maintained by queries layer 280 can provide business logic that can be applied to allow users and global market model clients (e.g., 220, 225, 230, 235) to pose various classes of market-related questions that can be answered by instantiating models and analyzing resulting model instances within global market model. For instance, query modules can embody business logic that can be applied to the data and structure of the global market model (and its constituent model type instances and data objects) to return market intelligence responsive to a particular query made by one or more users and global market model clients (e.g., 220, 225, 230, 235). Indeed, each query module in the library of query modules can include business logic for returning responses to a general category of market-related question types answerable through instantiations of global market models. Indeed, in some examples, query modules can return responses that include data from or pointers to a subset of model type instances of the global market model identified using the query module business logic.

In some implementations, a query engine of queries layer 280 can be provided for use in processing user and client inputs to translate the inputs into machine-usable query arguments (i.e., compatible with global market model and business logic corresponding to a respective query module). A query engine and/or particular query modules, in some examples, can further include at least a portion of the business logic used to extract data and intelligence from the global market model and return information from the global market model as a response. In some examples, such responses can be based upon a particular instantiation of at least a portion of global market model. For instance, a query relating to and requesting intelligence concerning a particular product, product category, or organization can involve the instantiation of one or more models or objects relating to the subject of the query (e.g., the corresponding, named product, product category, or organization). Indeed, in some examples, a query module can require, as an input, the identification of one or more particular instances of one or more particular model types that should be correspondingly accessed and interrogated using the business logic of the query. Accordingly, in some implementations and instances, a query engine can operate in coordination with model instantiation or identification tools of model layer 275 in connection with servicing user or client requests for market intelligence from the global market model.

Further, queries of and other requests on the global market model can be submitted by and received from a plurality of client systems (e.g., 220, 225, 230, 235). In some implementations, an interface (e.g., APIs to the global market intelligence engine 205) can be provided allowing some subset of query module functionality and global market model to be made publicly available, for instance, through a public webpage or web-based application accessible over the Internet. Outside applications and models, including third-party applications and/or models hosted by remote servers (e.g., 235) can also interface with the global market model using one or more APIs of global market intelligence engine 205. In some instances, access to particular query modules, content, data, and models of global market model can be limited and offered, for instance, on a subscription basis. As such, some instances of global market intelligence engine 205 can include client account manager tools to track subscriptions, authentication information, and authorization access and permissions for some or all of the users and clients (e.g., 220, 225, 230, 235) of global market intelligence engine 205.

In some instances, global market model can serve as a source of global market intelligence for a plurality of proprietary or enterprise-specific or -focused market models, management tools, and other systems used by enterprises in connection with their decision-making and other activities within the marketplace. Such tools and models can assist enterprises in optimizing actions and making decisions with regard to a wide array of market behaviors and decision, including supply chain decisions, marketing decisions, product development decisions, research and development decisions, resource allocation decisions, human resources decisions, among many others. For instance, enterprise-focused models can be provided that may combine private, enterprise-proprietary data and intelligence with global market intelligence provided through global market model. Indeed, in some instances, enterprise-focused models can be developed, provided, and/or hosted, for instance as a service, by the same entity responsible for developing and maintaining the global market model and global market intelligence engine 205. Indeed, in some instances, systems hosting and maintaining one or more enterprise-specific models can be collocated with global market intelligence engine 205. In other instances, systems (e.g., 235) hosting and maintaining one or more enterprise-focused models can be located remote from global market intelligence engine 205 and consume services provided by global market intelligence engine 205 in connection with global market model, for instance, via one or more networks (e.g., 240) and APIs of the global market intelligence engine 205. Further, in some examples, enterprise-focused models, as well as other outside models and applications interfacing with global market intelligence engine 205, can be developed and maintained by third-parties, consuming services and data provided by global market intelligence engine 205 in connection with global market model via one or more networks (e.g., 240) and APIs of the global market intelligence engine 205.

In one example implementation, an example enterprise system 235 can be provided in system 200 and host or otherwise maintain one or more enterprise-focused models or tools, including models, tools, and services dependent on data and services provided by global market intelligence engine 205 in connection with global market model. Enterprise-focused models can be developed, maintained, and used by an enterprise to assist the enterprise in optimizing and improving their decision making with regard to their participation and performance within the global marketplace. Enterprise system 235 can, in some implementations, include one or more business management, market intelligence, decision making engines, tools, or systems for use by decision makers in synthesizing and observing market intelligence in connection with their roles in the management of the enterprise. In some implementations, such a decision making engine can generate and/or manage informational feeds in accordance with one or more goals of an enterprise, the feeds utilizing data and market intelligence gleaned from enterprise models and/or global market model and its constituent model instances.

Enterprise-focused models can utilize data and market intelligence from global market model. Indeed, in some examples, an enterprise-focused model can be a customized version or instance of a model type included in the global market model, inheriting data, semantics, extensions, and structure from the global market model type's class but defining one or more custom attributes, attribute values, or sub-model types different from that provided in the global market model instance. Such enterprise-focused models can also utilize APIs of the global market intelligence engine 205, for instance, to interface with the global market model or query modules to update market data of the enterprise-focused model, formulate market intelligent requests of global market model used in the enterprise-focused model, point to or otherwise reference particular model type instances of the global market model, etc. In some instances, activities of example decision making engines or other tools of an enterprise system 235 can further coordinate with global market intelligence engine 205 to access data and query the global market model to obtain market intelligence for use within decisions of the enterprise. As an example, in some instances, results returned from the global market model can prompt the creation of a new data feed, also relying on the global market model, to send news, updates, and other data, in some cases in real time, for reporting to decision makers in the enterprise. For instance, a market intelligence request can be made of global market model to obtain market intelligence on potential market opportunities (e.g., market segments defined by customer segment, market region, and product category), and feeds can be established (e.g., utilizing functionality of global market intelligence engine 205) to track and report developments related to the identified potential market opportunities (e.g., thereby assisting decision makers in obtaining fresh data and appreciating substantially real-time developments influencing the enterprise's strategy and attempts to take advantage of the otherwise unknown or underappreciated opportunity).

Regardless of the type of consumer of the global market model, responses returned, for instance by the queries layer 280 can be rendered and presented to users in a variety of ways using, for instance, functionality of a user interface layer 285. An example user interface layer 285 can additionally provide user interfaces (Uls) permitting users' interaction with the global market model, including querying of the global market model. Additionally, user interfaces can be provided through user interface layer 285 allowing users, such as administrative users, to manage, build, and submit data for use in the global market model (e.g., in connection with data collection layer 270), and provide other maintenance tasks in connection with the global market model (e.g., in connection with model layer 275), among other examples.

III. Example Implementations of a Global Market Model and Query Modules

As noted above, a global market intelligence system can include and serve a global market model with a plurality of constituent models, data objects, and other data structures. In some examples, a global market model can be implemented hierarchically with some data structures dependent on, included in, encapsulated, or linked to other data structures or models of the global market model as sub-models of the respective model. For instance, in some examples, a global market model can exhibit a hierarchical structure and include instances of model types such as those included in Table 1:

TABLE 1

| Model | Sub-Model of | Description |
|---|---|---|
| Global Market | None | A top level model that captures all the interacting |
| | | elements of the global market. |
| Market Product | Global Market | Models all the elements of a commonly understood |
| Category | | good or a service that is traded in the global market |
| | | place. |
| Market Region | Global Market | Models a geographic region where organizations |
| | | and customers buy and sell the market product |
| | | categories. |
| Organization | Global Market | Models any organization that provides and/or buys |
| | | goods and/or services in the global market place. |
| Person | Global Market | Models and is used to capture information relevant |
| | | to any individual in the global market place. |
| Market Segment | Global Market | Models aspects of a distinct opportunity within a |
| | | particular segment of a market product category, |
| | | customer base, and/or regional market of the |
| | | global market and describes characteristics of |
| | | competitors' involvement and relative success |
| | | within the market segment. |
| Customer Segment | Global Market | Models all aspects of a specific customer segment |
| | | (e.g., end consumers) that buys products (or |
| | | services) in the particular market product category. |
| | | The customer segment for a particular market |
| | | product category can further be uniquely |
| | | characterized by market region to account for |
| | | regional preferences. |
| Market Product | Market | Models and defines a specific, commonly |
| Category Attribute | Product | understood attribute of the market product |
| | Category | category. Each category attribute for a particular |
| | | market product category can have a unique ID and |
| | | sub-models used to define the attribute. |
| Market Product | Market | Models and defines the typical components |
| Category Component | Product | included in products of the market product |
| | Category | category as well as the respective market product |
| | | categories of the components (i.e., each |
| | | component category is by itself a market product |
| | | category that is traded in the global market place). |
| Market Product | Market | Models and defines substitutability relationships |
| Category Substitute | Product | between product categories (i.e., that a particular |
| | Category | market product category is a potential substitute |
| | | for another product category). Each substitute |
| | | model for a particular market product category can |
| | | have a unique ID and sub-models used to define |
| | | the substitutability relationship (e.g., potential |
| | | risks/opportunities for substituting one market |
| | | product category for another, etc.). |
| Market Product | Market | Models and defines accessory relationships |
| Category Accessory | Product | between product categories (i.e., that a particular |
| | Category | market product category is a potential accessory |
| | | for a given market product category). |
| Market Product | Market | Models and defines the relationship between the |
| Category Sub | Product | parent product category and a sub-category of the |
| Category | Category | market product category. |
| Product Category | Market | Models and defines a feature or attribute that is |
| Feature | Product | typical among products in the respective market |
| | Category | product category. The actual value for a product |
| | | feature or attribute is stored on each Product |
| | | model. |
| Value Chain Role | Global Market | Models and defines commonly understood roles |
| | | that organizations play within the value chain of a |
| | | respective market product category. |
| Product | Organization | Models the details of a specific product offered by |
| | | the organization in the global market place. |
| | | Attributes can include the associated market |
| | | product category, specific features of the product, |
| | | product lifecycle dates, pricing, regions and |
| | | channels it is offered in, the share it achieved, |
| | | forecasts for future time periods, etc. |
| Product Group | Organization | Models the details of specific product lines/brands |
| | | offered by the organization in the global market |
| | | place. |
| Facility | Organization | Models physical facilities of the organization (e.g., |
| | | retail stores, distribution centers, factories, offices, |
| | | etc.). |
| Inventory Node | Organization | Models the inventory policies adopted by the |
| | | organization for a specific product or product group |
| | | at a particular facility or across a group of facilities. |
| | | Attributes can include the safety stock policies, |
| | | replenishment policies, supply chain network for |
| | | replenishing the inventory node, actual and |
| | | estimated on-hand inventory by time period, etc. |
| Supply Chain Activity | Organization | Models any supply chain activity in an organization |
| | | (e.g., production, distribution, procurement, etc.) |
| | | including the lead times for the activity, supply |
| | | chain costs, and resources consumed in the activity, |
| | | etc. |
| Market Size Forecast | Market | Models and describes the market size actuals and |
| | Segment | forecasts for a particular market segment over a |
| | | period of time. |
| Market Share Driver | Market | Models and describes the key drivers of share for |
| | Segment | a particular market segment. |
| Market Share Drivers | Market | Models and describes the forecast of the market |
| Forecast | Segment | share drivers' relative importance for a particular |
| | | market segment. |
| Market Share | Market | Models and describes the market share actuals and |
| Forecast | Segment | forecast (units, revenue, profit pool, etc.) by |
| | | organization competing in a particular market |
| | | segment. |
| Organization | Organization | Models and describes the share actuals and |
| Category Share Split | | forecasts of the share of an organization's |
| | | product(s) purchased by a particular buyer (e.g., in |
| | | a particular market region for a particular market |
| | | product category). Organization category share split |
| | | models can include sub-models that help capture the |
| | | assumptions and analytics used in the generation of the |
| | | share split forecast. |

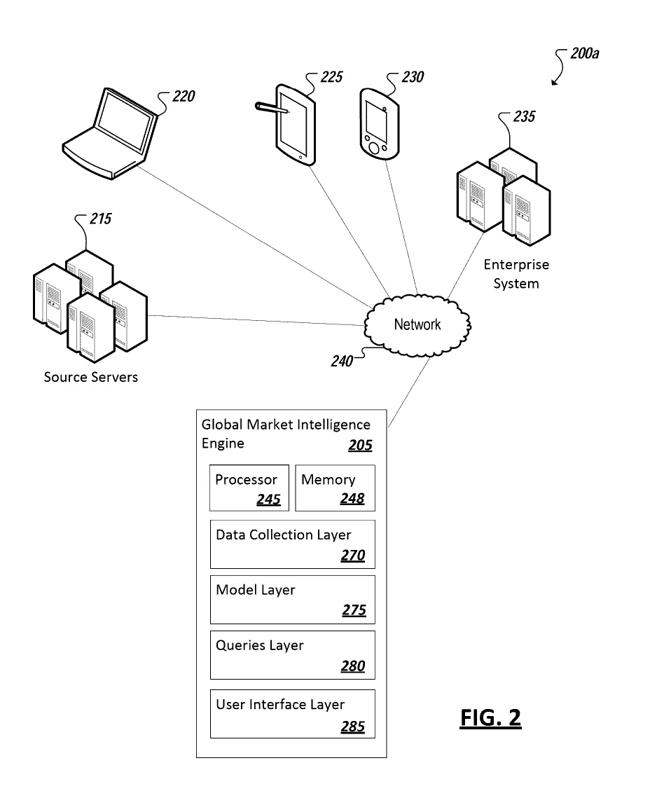

Turning to FIG. 3A, a simplified representation 300a is shown representing principles of an example global market model modeling the global marketplace, as well as the querying of the global market model to provide market intelligence to a variety of users of the global market model. An example global market model (e.g., 305) can contain instances of a market product category model type (e.g., 310), a market region model type (e.g., 315), and a customer segment model type (e.g., 328). Further, a plurality of market segments can be modeled (by instances of a market segment model type, e.g., 326) representing intersections of respective market product categories, market regions, and customer segments. Further, instances of a market size forecast model type (e.g., 494), market share driver model type (e.g., 495), market share driver forecast model type (e.g., 497), and/or market share forecast model type (e.g., 496), among others, can be provided modeling attributes of these market segment opportunities, as well as a network of organization model type instances and product model instances (e.g., 320, 446) related to the modeled market segment. Market intelligence modeled by one or more of these model instances can be queried using a library of structured query modules (e.g., 330) utilized by a query engine (e.g., 322), the query modules including business logic enabling the global market model (305) to be interrogated and allow the users (e.g., 324) of the system to gain insights into the market(s) modeled by the global market model (e.g., 305).

Turning to FIG. 3B, a schematic diagram 300b is shown representing one particular example of a global market model 305 and a query library 330 of query modules that can be run to intelligently answer questions concerning the markets modeled by the global market model. The particular example global market model 305 of FIG. 3B can include various sub-models, data objects, and other data structures for modeling the global marketplace including the value chains of one or more particular markets within the global marketplace. For instance, in the present example, global market model 305 can include models of dimensions of the global market place, including a market product category model 310, geographic market region model 315, organization model 320, market segment model 326, value chain role model 327, and customer segment model 328, among potentially many other models, such as those listed and described in Table 1. Indeed, global market model 305 can be an extensible model and additional model type instances and model types can be easily added or incorporated within the global market model 305, for instance, to model additional other attributes, entities, or relationships identified within the global marketplace. In some respects, global market model 305 can represent a catalog of instances of model types 310, 315, 320, 326, 327, 328, etc. Further, models (e.g., 310, 315, 320, 326, 327, 328) included in global market model 305 can also include sub-models, objects, attributes, business logic, and other data structures and can interface with, obtain data from, and/or include hierarchical dependencies to other sub-models in global market model 305, such as the example hierarchical structure outlined, in part, in Table 1.

Market intelligence requests and questions can be formulated and applied against instantiations of one or more model types (e.g., 310, 315, 320, 326, 327, 328, etc.) included in global market model 305. “Queries” can represent general categories of questions that can be asked relating to markets modeled by global market model 305 and its constituent models. For instance, a particular question, query term, or other request for market intelligence from the global market model 305 can be matched to business logic of one or more query modules (e.g., 335-398) adapted to generate responses to particular categories of market-related questions from the structure and content of the global market model 305 and its constituent models. A natural language query or question, inputs received at a query-building wizard, or other inputs received by a global market intelligence engine and/or query engine from a user or client system can be translated into a machine-usable, structured argument (e.g., including parameters corresponding to or named in the natural language question) for processing using the logic of one or more query modules. For instance, a natural language query or question can be translated into a structured query argument with parameters including one or more filter expressions and, in some cases, one or more particular model types or model type instances, based on the natural language inputs. One or more query modules 335-398 can be identified that include logic that would be responsive to the interpreted natural language query or question. The identified query modules 335-398 can then be used to process the constructed arguments and utilize corresponding business logic to identify relevant models of the global market model and return an answer, or query response, to the input based on an analysis of, filtering of, or identification of market intelligence provided through the one or more identified models in global market model 305.

A library of query modules can be provided through business logic that can be applied against the global market model to return responses to particular queries. For instance, in some examples, business logic can be provided that can be applied against a global market model to return query responses, based on particular identified query parameters, to categories of questions handled by query modules in a library of query modules. Structured expressions can be developed from received queries that are adapted to be accepted and processed as inputs by the respective query modules. For instance, a query module can accept the identification of a particular model type or model type instance as well as other parameters and conditions included in a filter expression corresponding to the query. Table 2 provides a listing of examples of query modules and corresponding expression parameters that can be applied against the global market model to return responses to corresponding queries:

TABLE 2

| Query Module (Parameters) | Output |
|---|---|
| Market Product Categories | Generates responses to queries where the response includes generation |
| (<Filter Expression>) | of a list of all top level market product categories that are offered in |
| | the global market place, i.e., market product categories that do not |
| | have any parent market product categories specified. In one example, |
| | the query can return Televisions, Computers, Tablets, Mobile |
| | Devices, Footwear, etc. as market product categories, if these are |
| | defined as the top level product categories in a specific instance of |
| | the global market model. |
| Market Regions | Generates responses to queries where the response includes |
| (<Filter Expression>) | generation of a list of market regions where products are traded in the |
| | global marketplace satisfying the attributes specified in the filter |
| | expression. |
| Organizations | Generates responses to queries where the response includes generation |
| (<Filter Expression>) | of a list of organizations participating in the global marketplace |
| | satisfying the attributes specified in the filter expression. |
| People | Generates responses to queries where the response includes |
| (<Filter Expression>) | generation of a list of persons in the global marketplace |
| | satisfying the attributes specified in the filter expression. |
| Category Competitors | Generates responses to queries where the response includes |
| (Market Product Category, | generation of a listing of competitor organizations in a particular |
| Value Chain Role, | market product category in a particular market region. |
| <Filter Expression>) | |
| Organization Competitors | Generates responses to queries where the response includes |
| (Organization, Market | generation of a list of competitor organizations for a particular |
| Product Category, | enterprise participating in the particular market product category |
| <Filter Expression>) | in the particular market region. Competitors are identified |
| | as corporations having the same value chain role with |
| | respect to that market product category. |
| Competitor Categories | Generates responses to queries where the response includes |
| (Market Product Category, | generation of a list of market product categories that can |
| <Filter Expression>) | be considered as “competitor” categories for a given market |
| | product category in the global market according to attributes |
| | of the specified filter expression. |
| Customer Segments | Generates responses to queries where the response includes |
| <Filter Expression>) | generation of a list of customer segments in the global |
| | marketplace that satisfy the criteria specified by the filter |
| | expression. |
| Channel Partners | Generates responses to queries where the response includes generation |
| (Organization, | of a list of organizations that can be channel partners (indirect |
| Market Product Category, | customers) for a particular enterprise (i.e., other organizations that |
| Market Region, | assist in moving products and services from the particular enterprise |
| <Filter Expression>) | to end customers). Channel partners can be identified by the |
| | system using the relations between value chain roles. For example, |
| | “retailers” for a particular market product category can be channel |
| | partners of “brand manufacturers” of the same product category. |
| | Further, by providing a status indicator (e.g., “active”), the list |
| | of channel partners can be pruned down to list only those |
| | channel partners that are currently customers of the focus |
| | organization (i.e., and not potential customers). |
| Value Chain Suppliers | Generates responses to queries where the response includes generation |
| (Market Product Category, | of a list of organizations that can be suppliers from the perspective of |
| Value Chain Role, | a value chain role for a particular market product category. Suppliers |
| <Filter Expression>) | can be identified by the system using the value chain role |
| | relationships (e.g., “brand manufacturers” are suppliers of |
| | “retailers”) as well as component product category relationships |
| | for the particular market product category and the organizations |
| | that sell those component market product categories in the global |
| | market place (e.g., TV displays are a component category of the TV |
| | category and suppliers of TV displays will be suppliers of brand |
| | manufacturers of TVs). |
| Competitive Product | Generates responses to queries where the response includes generation |
| Landscape | of a list of competing products provided by the organizations defined |
| (Market Segment, | as competitors within a particular market segment. Alternatively, |
| <Filter Expression>) | Competitive Product Landscape query module can generate responses |
| | according to the particular market product category, market region, |
| | and/or time period of a particular market segment. |
| Relations | Generates responses to queries where the |
| (Market Product Category, | response includes generation of a listing of other |
| <Filter Expression>) | market product categories that are related to a |
| | named market product category in a particular |
| | way. The relation type can include substitutes, |
| | accessories, sub-categories, components, etc. |
| Forecasted Market Segments | Generates responses to queries where the |
| (Market Product Category, | response includes generation of a list of market |
| <Filter Expression>) | segments for the specified market product |
| | category for which market size forecasts are |
| | generated and according to attributes of the |
| | specified filter expression. |
| Market Size Forecast | Generates responses to queries where the |
| (Market Segment, | response includes generation of a market size |
| Time Period, | forecast for the specified market segment |
| <Filter Expression>) | according to the attributes of the specified filter |
| | expression. |
| Best Market Size Forecasts | Generates responses to queries where the |
| (Market Segment, | response includes generation of a listing of the |
| Time Period, | most accurate market size forecasts (e.g., the top |
| <Filter Expression>) | ten most accurate forecasts) for the specified |
| | market product category, market region and time |
| | horizon based on internal estimates of prior |
| | forecast accuracy. |
| Best Market Share Forecasts | Generates responses to queries where the |
| (Market Segment, | response includes generation of a listing of the |
| Time Period, | most accurate market share forecasts (e.g., the top |
| <Filter Expression>) | ten most accurate forecasts) for the specified |
| | market product category, market region and time |
| | horizon for organizations in the specified value |
| | chain role, based on internal estimates of prior |
| | forecast accuracy. |
| Share-winners | Generates responses to queries where the |
| (Market Segment, | response includes generation of a listing of top |
| Time Period, | share-winning products (as specified by the count |
| <Filter Expression>) | (e.g., top ten, top five, etc.) in the particular |
| | market product category, in the particular market |
| | region, in the specified time period, across the |
| | competitive set defined by the organizations |
| | playing the specified value chain role. |
| Share Drivers Ranking | Generates responses to queries where the |
| (Market Segment, | response includes generation of a listing of the key |
| Time Period, | drivers of share and their relative importance for a |
| <Filter Expression>) | particular market segment further according to |
| | attributes of the specified filter expression. |
| Share Driver Comparison | Generates responses to queries where the |
| (Market Segment, | Filter response includes generation of a comparison |
| Time Period, | of actual values for the share driving attribute for a |
| <Filter Expression>) | set of competing products. The set of competing |
| | products can be defined using the Share-winners |
| | query to compare share-driving factors of the top |
| | share-winning products in some instances. |
| Demand Change What-Ifs | Generates responses to queries where the |
| (Market Segment, | response includes generation of information |
| Time Period, | describing, for a particular market product |
| <Filter Expression>) | category in a particular market region, the impact |
| | of changes in demand, changes in market share |
| | assumptions of a particular organization, or |
| | changes in share split assumptions across supplier |
| | organizations for a particular buying organization. |

In the particular example of FIG. 3B, a library 330 of query modules can include at least an organization channel partners query module 335 (e.g., adapted to provide answers to question and queries concerning the identification of channel partners of organizations within particular value chains), market product category competitors query module 340 (e.g., adapted to generate answers to questions and queries concerning the identification of competitors within particular product market categories), value chain suppliers query module 345 (e.g., adapted to generate answers to questions and queries concerning the identification of actual and potential suppliers within particular product markets), demand change query module 350 (e.g., adapted to generate answers to questions and queries relating to predicted effects across a value chain in response to demand changing events in the value chain), competitive landscape query module 355 (e.g., adapted to generate answers to questions and queries relating to the comparison of competing product features), and product competition query module 360 (e.g., adapted to generate answers to questions and queries relating to the comparison of competing products (current and forecasted) against particular share, price and cost drivers of the products). Further, query library 330 can further include market size forecast query module 365 (e.g., adapted to forecast, compute, and estimate total market size (e.g., by units and/or profit pool, etc.) for a market segment (e.g., by region and/or product category, etc.)), share drivers ranking query module 370 (e.g., adapted to rank the importance of and identify, forecast, and return market intelligence relating to key factors and product features influencing share in particular market segments as well as their sensitivity to share (i.e., by returning a rank-ordered listing)), price drivers query module 375 (e.g., adapted to identify, forecast, and return market intelligence relating to key factors and product features influencing pricing in the market segment and their sensitivity to price), customer segments query module 380 (e.g., adapted to identify customer segments of a market, as well as the likes and dislikes, demand drivers, demographic information, growth trends, preferred channels, market size, and other information relating to particular customer segments modeled by the global market model (e.g., in customer segment model 328)).

Still further, the query library 330 can include a market product categories query module 382 (e.g., adapted to identify a set of market product categories satisfying particular criteria specified in parameters of the query), market regions query module 385 (e.g., adapted to identify a set of market regions satisfying particular criteria specified in parameters of the query), people query module 388 (e.g., adapted to identify a set of persons satisfying particular criteria specified in parameters of the query), forecasted market segments query module 390 (e.g., adapted to identify a listing of markets segments for a particular market product category involved in a particular market forecast of the market product category), organization competitors query module 392 (e.g., adapted to identify a set of organizations (e.g., enterprises participating in the market) satisfying particular criteria specified in parameters of the query), competitor categories query module 395 (e.g., adapted to identify a listing of competing organizations within a specified or returned market product category), share-winning products 396 (e.g., adapted to identify the top number of share-winning products across a set of competing organizations within a particular market product category, market region, market segment, etc.), and share driver comparison query module 398 (e.g., adapted to return the respective values of share drivers of various competing (or compared) products), among potentially other example queries.

In some instances, query modules in query library 330 can apply the business logic of the query module to more than one market intelligence model. For instance, a query module can be applied to the global market model 305 and at least one other market model, such as another market intelligence model provided by a remote third-party system. In such instances, the particular model (e.g., global market model) can be identified as a parameter in thy query and used by the query module to filter handling of the query to the identified model. Indeed, in one example, query library 330 can include a market model instance query 378 adapted to return the instances of various global market models, that are available to a particular system (e.g., the market intelligence system hosting or otherwise utilizing the query library 330). Not only can query modules of query library 330 be reusable across multiple modeling environments, in some implementations, query library 330 can be extensible, allowing for additional query modules to be developed and conveniently added to and supplement the business logic of existing query modules of the query library 330.

As noted above in Table 2, each query module can receive and use various parameters that can be used to identify corresponding model instances and drive the business logic used to return results from the identified model instances. A filter expression can include a variety of arguments, additional parameters, and operators that can be used to further drive the application of particular business logic to the model instances. Such parameters, including the filter expression can be recognized and translated from user-provided natural language queries. As an illustrative example, a market product categories query module can be used to answer a natural language question such as “What are all the market product categories that have a revenue market size for 2012 greater than $1 billion in the US market?”. The nature of the question (e.g., requesting an identification of market product categories) can be interpreted and used to identify that the market product categories query module is adapted to process the query and attributes (e.g., revenue greater than $1 billion, United States geographical region, 2012 time period, etc.) of the query can be interpreted as parameters for use in the market product categories query module (e.g., as a filter expression parameter). The market product categories query module can then identify model instances including data and modeling such aspects as various market product categories, market size, market regions, etc.

As further examples, a market regions query module can be identified to respond to queries such as “What are the market regions of type counties within the USA region that have greater than 10000 households with yearly income >100,000 USD?.” A customer segments query module can be identified and used to generate responses to queries such as “What are the customer segments associated with the Television product category in the USA market region?” or “Which customer segments are forecasted to have the largest market size for the automobile market product category in India market in 2012?”. In another examples, an organizations query module can be identified and used to answer such queries as “What are the organizations that are brand manufacturers of televisions and sell their products in the US?” or “What organizations supply components to brand manufacturers of televisions globally?”. A forecasted market segments module can be used to respond to queries such as “What are the forecasted market segments for the television category?,” and a category competitors query module can be used to answer such questions as “Who are the competing brand manufacturers of television product category in the USA market?”. Further, an organization competitors query module can be used to respond to queries such as “Who are the top 10 competitors of Samsung in the television market?”, and an organization channel partners query can be identified and user to respond to a query such as “Who are the potential distributors of televisions in the US market not currently doing business with LG?”, among others.

In still further examples, a value chain suppliers query module can be identified and used in responses to such queries as “Who are the suppliers of brand manufacturers of televisions located in Japan?”. In another example, a competitive product landscape query module can be identified and used to answer a question such as “What competing smart phones are expected to be in the US market in 2012 Q1 and Q2?”. A competitor categories query module can be identified to respond to such questions as “What are the competitor categories for laptop market with a higher growth rate in 2011 than laptops?”. The response might include a listing of competitor categories such as tablet computers, smart phones, etc., as an example. Further, a share-winning products query module can be used to respond to questions such as “What are the top 5 share winners for smartphones in the US in Q4 2011?”. Additionally, a share drivers ranking query module can return results relating to leading share drivers in a market, including such example queries as “What are the top 10 share drivers for the $400-$600 non-subsidized priced smartphones in the US in Q4 2011?”. A share driver comparison query module can handle queries relating to the comparison of share drivers in a market, such as “How did the features of Smartphone X compare against the top 3 share drivers for smartphones in 2011?”. A market size forecast query module can be identified and respond to queries such as “What is the market size forecast for 32-37 inch flat screen television in the US in 2012-2014?”, and a demand change query module can be identified to respond to queries relating to forecasted demand change effects, such as “Who are the impacted brand manufacturers and suppliers of brand manufacturers if the demand for tablets in Q2 2012 exceeds the current forecast by 5%?”, among other examples.

In some instances, multiple query modules can be identified, invoked, and used to respond to a particular query. Indeed, in some instances, a single request for market intelligence, or query, can constitute a chain of queries for which multiple different query modules are called to handle. As an example, a query such as “How do the features of sports car ABC compare against the top 5 share drivers for automobiles in Germany?” can, in some implementations, involve first determining the top five share drivers for the German automobile market (e.g., using a share drivers ranking query module) and then using the results of this first sub-query in a determination of comparisons to the identified top five share drivers (e.g., using a share driver comparison query module).

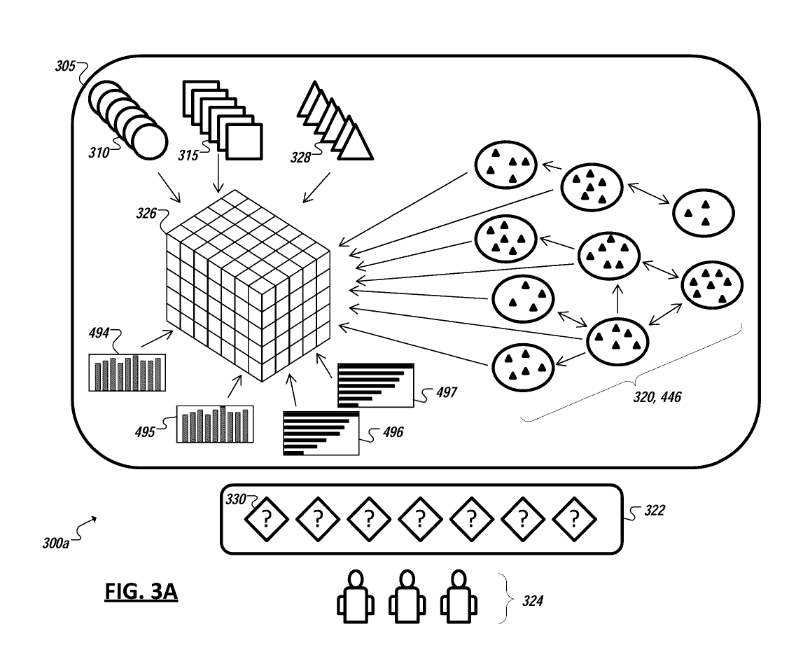

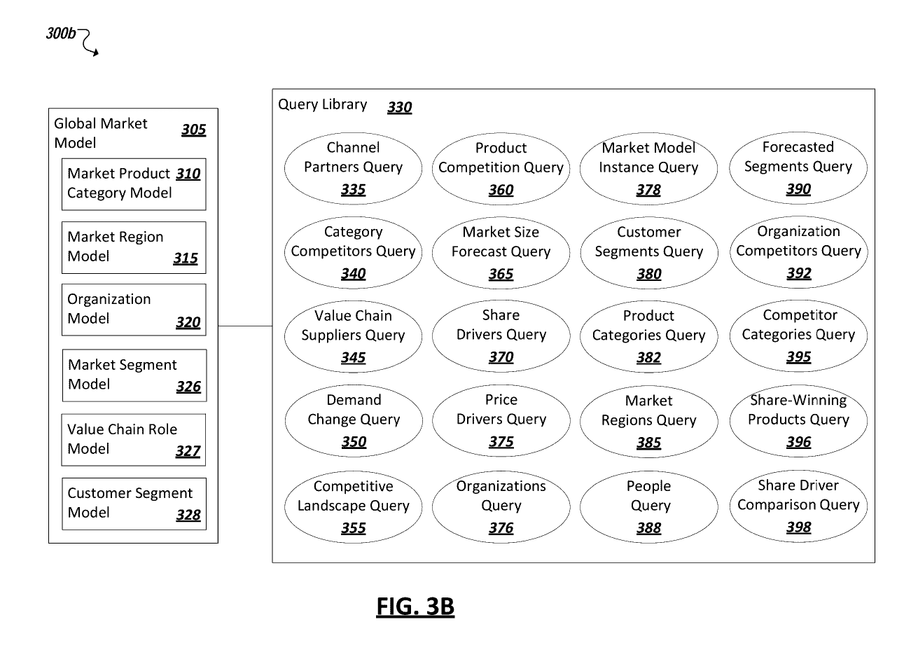

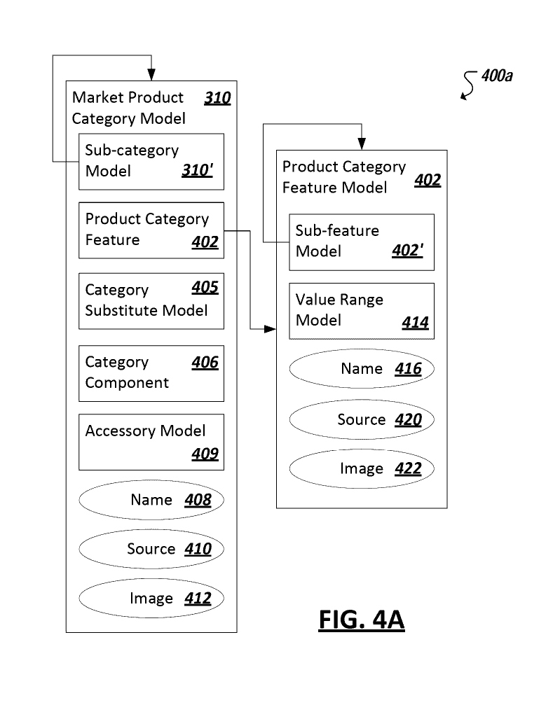

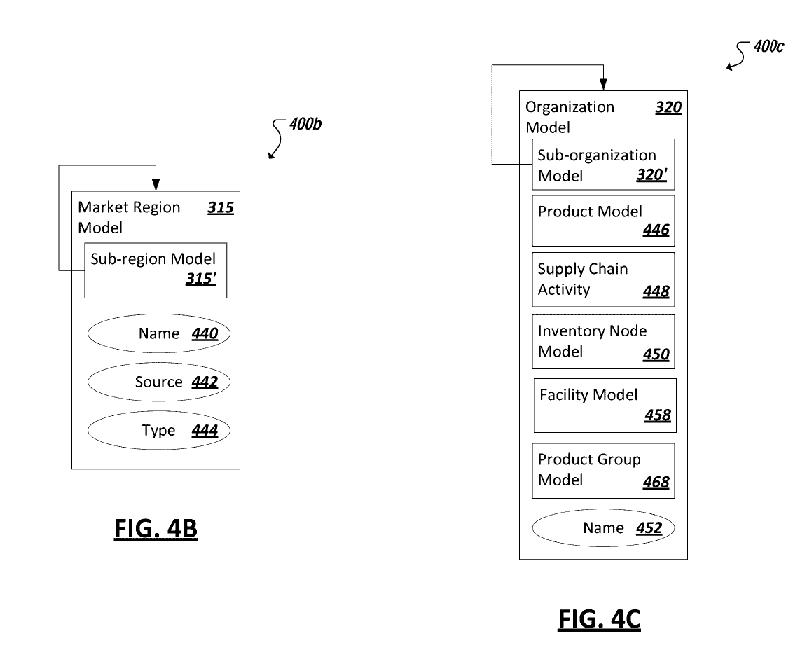

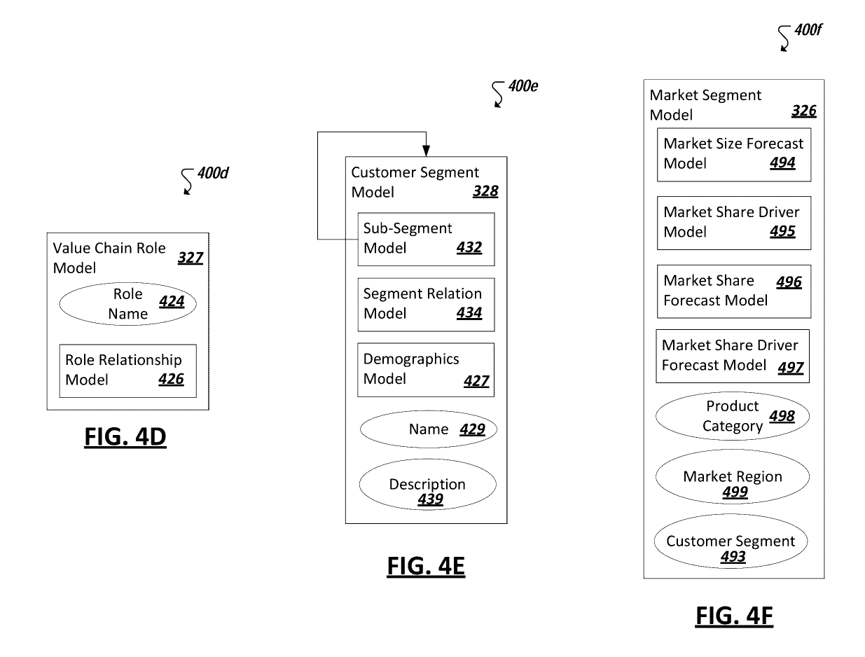

Turning to FIGS. 4A-4G, simplified block diagrams 400a-g are shown representing the structures, attributes, relationships, and additional details of software model types included in one particular example of a global market model, such as example global market model 305. As represented in FIG. 4A, a block diagram 400a representing an example market product categories model type 310 of global market model 305 is shown. A market product category model type 310 can be instantiated for any one of a set of defined market product categories, the set, in some instances, ideally including most or all of a universe of standard product categories and sub-categories known to exist in the global marketplace. A market product category model type 310 can be instantiated as software models representing any one of a set of commonly-accepted product categories (goods or services) that organizations compete in or plan to compete in. For example, a market product category model can be created named “Television” representing all television products offered in the market. To facilitate modeling of a market product category, a market product category model type 310 can include, for example, identifications of organizations competing in or planning to compete in the corresponding product category market as well as each organization's respective role(s) (e.g., manufacturer, distributor, retailer, etc.) in the value chain for that product category. A market product category model type 310 can further enable comparison of products offered by one organization against another. A set of pre-defined product categories can be provided in the global market model 305 and can be potentially supplemented, changed, or otherwise refined by users adding intelligence to the model. In some instances, custom and modified categories can be specified but adopted in proprietary or organization-focused models and not in the global market model itself.

In the particular example of FIG. 4A, each instantiation of market product category model type 310 can include instances of sub-model types including a sub-category model type 310′, product feature model type 402, category substitute model type 405, category component model type 406, and accessory model type 409, among other potential sub-model types. Further, each instantiation of market product category model type 310 can include various attributes defining characteristics of the instantiated model's corresponding market product category. For instance, attributes can include the name of the product category 408, identification of sources 410 of data used to populate the model attributes (as well as the model instance's respective sub-models), an image 412 representative of the product category (e.g., a refrigerator, television, smartphone, breakfast cereal box, or other image representing the general product category represented by the model instance), among potentially other attributes not shown.

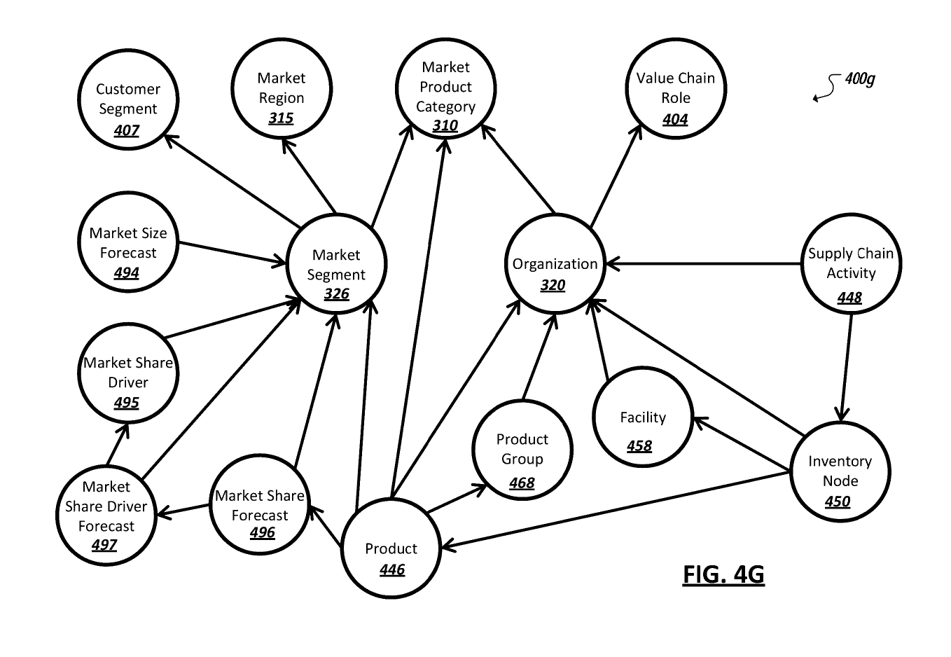

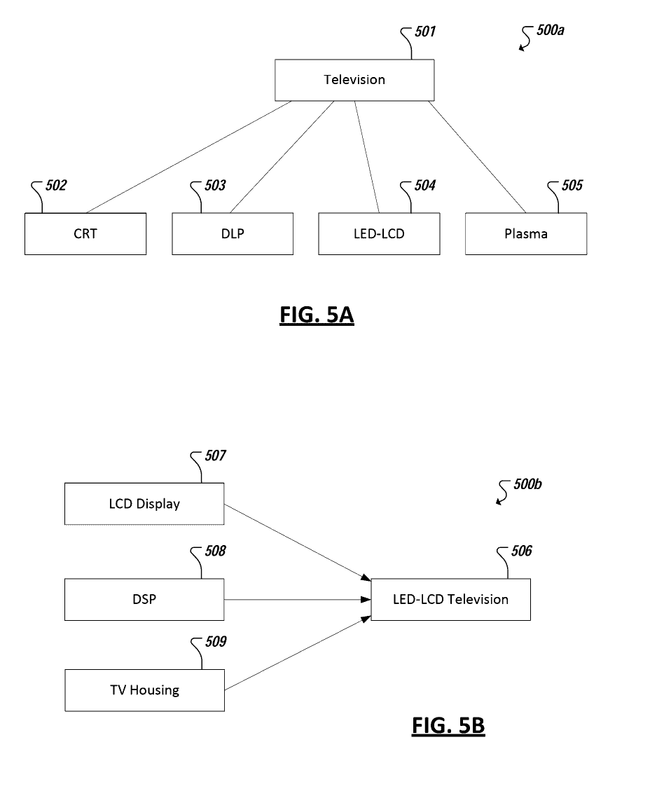

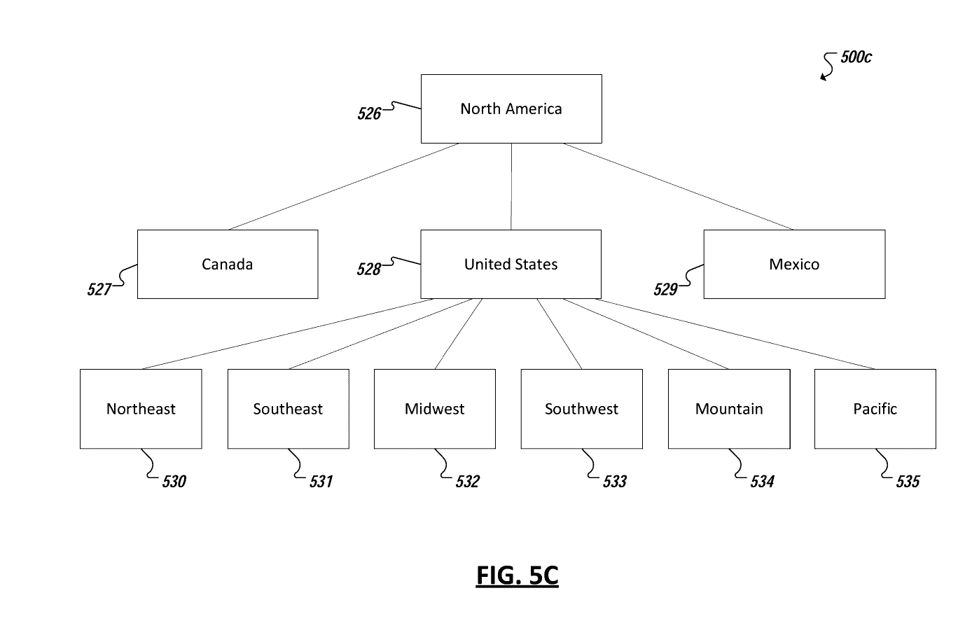

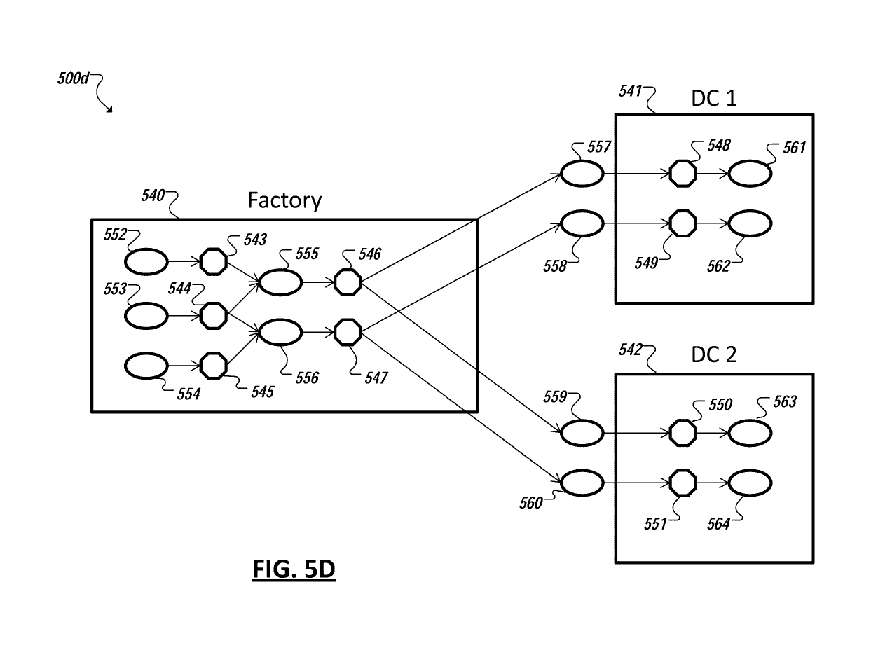

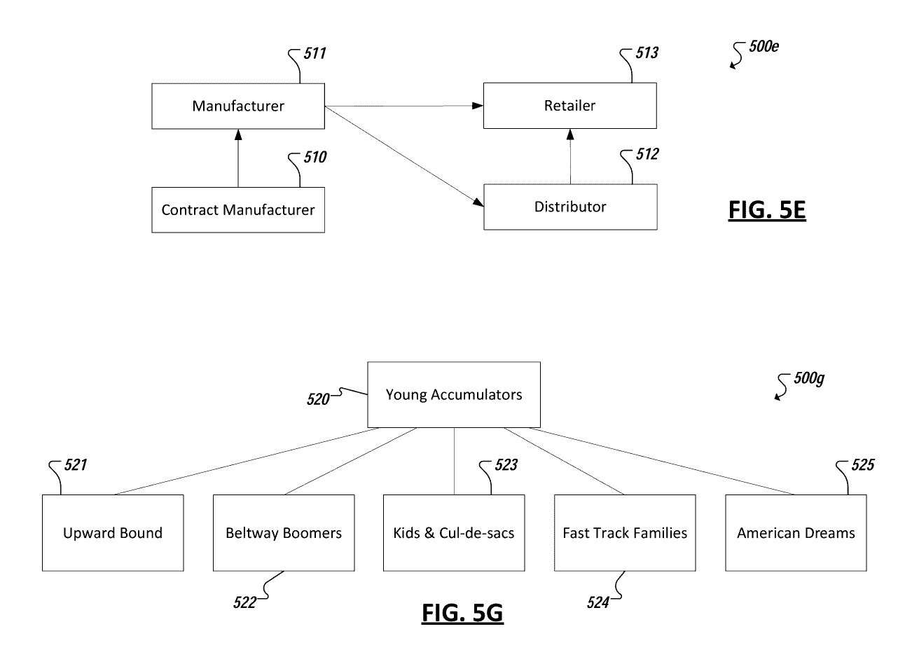

A given market product category can include sub-categories of the product category. For instance, a smart phone product category can include sub-categories such as touchscreen smart phones, MP3 player smartphones, Wi-Fi-enabled smartphones, etc. Each sub-category of a market product category can have an associated model instance, the sub-category itself being modeled by an instance of product category model (e.g., 310′). Indeed, market product category models can be arranged in a hierarchy, with higher level market product category models representing a broader categorization, and lower level market product category models representing a narrower categorization that is fully contained within the broader categorization. To illustrate, FIG. 5A illustrates a simplified block diagram 500a representing a hierarchy of market product category models within a “Television” market product category. A “Television” market product category model 501 can have children subcategories defined according to technology and modeled by model instances 502-505. For example, a product in the market that belongs to the “LED-LCD” market product category also belongs to the “Television” market product category, modeled by model instances 504 and 501 respectively.

Market product category models may also be related to one another according to numerous relationships between product categories such as “accessory”, “component” and “substitute.” A market product category model is an accessory to another market product category model if products in that category are often purchased to be used with products in the other category. An example would be “Remote Control” as an accessory market product category to “Television,” among many other examples.

A market product category model is a component to another market product category model if products in that category are used in the manufacture of products in the other category. To illustrate, FIG. 5B is a simplified block diagram 500b representing the relation of an example market product category model “LED-LCD Television” (e.g., 506) to its component market product category models. An LED-LCD television can be manufactured from several components that are manufactured and sold as products by other companies and have corresponding instances of a market product category model. For instance, the market product category models for such component products can include “LCD Display” (e.g., 507), “DSP” (e.g., 508), and “TV Housing” (e.g., 509). The market product category models for the components (e.g., 507-509) have a component relationship to the market product category model “LED-LCD Television” (506).

A market product category can be considered a substitute to another market product category if customers might choose products from either category to satisfy their demands. Substitution can be a reciprocal relationship, so that if category A is a substitute for category B, then category B is also a substitute for category A. An example of substitution between market product categories can be “Laptop Computers” and “Tablets,” if it is determined that some segment of customers may see their purchase as an either/or choice between products from the two categories. Further, whether defined as an accessory, component, or substitution, relationships between two or more market product categories can be defined in fields of the respective model instances.

Accordingly, returning to the discussion of FIG. 4A, a market product category model type 310 can include sub-model types, including a category substitute model type 405, category component 405 model type, and accessory model type 409 modeling relationships between two or more market product categories, such as those described in the examples of FIG. 5A. For example, instances of a category substitute model type 405 can model substitutability relationships between market product categories, such that a first market product category is considered a potential substitute for another given product category. Additionally, instances of a category component model type 406 can model or define component relationships between market product categories, such that one market product category is considered a sub-component of another. Further, market product category accessory models 409 can model and define accessory relationships between product categories, such that a first market product category is considered a potential accessory for another given market product category, among other examples.

Further, each instantiation of a market product categories model type 310 can further include instances of a product category feature model type 402, the model type 402 defining a standard set of features typically included in products within the product category. Accordingly, an example product category feature model type 402 can be instantiated for each identified feature in a set of features defined for the product category and include sub-model types such as a sub-feature model type 402′ and value range model type 414, and model attributes such as the name 416 of the feature, the identification of sources 420 of data used to populate the model attributes (as well as the model instance's respective sub-models), and an image 422 representing the feature, among potentially others. Sub-features of a modeled feature can likewise be modeled by an instance of product category feature model type 402 (i.e., 402′). As an example, for an automobile product category, radial tire can be defined as a feature, with a corresponding product category feature model 402 being instantiated for radial tires generally, the varying types and features of radial tires defined as sub-features with their own corresponding instances of product category feature model type 402′. Value range models 414 can define values for the known product category features to be defined for each respective product identified as belonging to the product category. For instance, in a television product category, one feature might include output power, with attributes defining the units of measurement (e.g., watts), and range of acceptable values for the feature, among other characteristics and attributes. A product category feature model type 402 and value range model type 414 can be used, in some instances, in connection with logic and rules used in scrubbing, validation, and preparation of data collected for inclusion in global market model 305.

Turning to FIG. 4B, a block diagram 400b is shown representing example market region models 315 of global market model 305. A market region model 315 can include a model defining and listing geographic regions where organizations compete or plan to compete in the global marketplace. Market region model 315 can include a hierarchical catalog of geographical locations where goods and services are sold and consumed. Geographic locations in market regions model can include regions defined by national political borders (i.e., countries) as well as the countries' respective sub-regions such as states, provinces, counties, cities, and postal codes. Customized regions, such as a company's own custom-defined distribution regions, markets, etc., can be defined by individual organizations to create customized region hierarchies, for instance, in an organization-focused model interfacing with global market model 305. Further, associations can be defined between customized regions and regions defined in market region model

In one example of market region model 315, for each defined region an instance of market region model 315 can be created including, for instance, one or more sub-models, such as sub-region models 310′ corresponding to sub-regions of the modeled region. As an example, a “United States” market region model instance can include sub-region model instances for each of the fifty states (i.e., sub-regions). Accordingly, instances of market region model 315 can be instantiated (as 315′) for each of the fifty states, with further sub-regions being defined for each state, such as by county, city, zip code, etc. Indeed, market region models can be arranged in a hierarchy. For instance, FIG. 5C includes a simplified block diagram 500c representing an example hierarchy of particular market regions. For instance, the market region model “North America” (e.g., 526) is parent to market region models “Canada” (527), “United States” (e.g., 528), and “Mexico” (e.g., 529). The “United States” market region model 528 can, in turn, be a parent to several market region models (e.g., 530-535), and so on. Further, each instance of market region model 315 can include attributes such as the name of the region, an identification of a data source corresponding to the region, and a type of the region (e.g., “national,” “state,” “county,” “postal area,” etc.), among other potential attributes.

FIG. 4C illustrates a simplified block diagram representing an example organization model type 320 of global market model 305. An organization model type 320 can include a model capturing all available information about organizations that are offering goods and services to the global marketplace including non-profit organizations, for-profit enterprises, government agencies, and other market participants. Such information can include the name, legal structure, focus, website, headquarters, and other information describing the organization and its participation in the global marketplace. In some instances, data in organization models 320 can be verified, supplemented, and corrected by users of global market model, such as users verified to be authorized by the organization to modify information included in a corresponding instance of an organization model type 320.

In the example of FIG. 4C, instances of organization model type 320 can be generated for each identified organization in the global marketplace. Instances of organization model type 320 can each include respective instances of sub-model types such as a sub-organization model type 320′, product model type 446, supply chain activity model type 448, inventory node model type 450, facilities model type 458, product group model type 468, among potentially other sub-models of other types, such as customer models (modeling specific customers of the organization), and others. A product group model type 468 can be used, for instance, to create a plurality of product group models, each product group model belonging to an organization and representing a grouping of product models according to shared product attributes such as brand or product line. Further, attributes can be defined in the model instances including the name 452 of the organization), among other potential attributes such as the legal structure of the organization (e.g., corporation, partnership, non-profit, etc., for use identifying potential governmental filings and other data sources describing aspects of the organization), the website of the organization (e.g., representing another potential source of data describing the organization), etc.

Continuing with the example of FIG. 4C, an example product model 446 can be instantiated for each of a plurality of products (e.g., goods and/or services) offered by the particular organization modeled in the organization model type 320 instance. Instances of a product model type 446 can include a model capturing individual products (i.e., goods and/or services) of an organization modeled by an instance of organization model type 320. Products models 446 can include all available information describing characteristics and features of the individual products offered by a particular organization within particular market product categories. Indeed, given a product model's association with a market product category model, it is also associated with a plurality of market segments in which the product is sold. A product model 446 can define product features and characteristics for a particular product offered by the organization, in particular those features and characteristics identified or considered to be share, price, and/or cost drivers for the corresponding product or market product category including product lifecycle dates, pricing models, historic sales (by market segment), and forecasts of future sales (by market segment). Product model type instances 446 can be used, for instance, to identify and generate comparisons of competing products, as well as model how changes to particular products (i.e., to features considered important share, price, or cost drivers for the product) can influence price, inventory, market share of the product(s), among other examples. Further, a product model need not represent a product that is already available in the market, but can also represent future products that are expected to be available in the market. Users of the system can create product models that represent their best guess at what products organizations may introduce and project what the feature set of those products might be.

In some instances, product model type 446 can include additional sub-model types, such as a target market model type, a product feature model type, among others. Further, product models 446 can include attributes including the name of the product, organizations associated with the product, an image of the product, any parent products of the product (e.g., where the product is a sub-component of another parent product), among other examples. A product features model can include features of the product pulled, for instance, from a corresponding market product category model 310 instance (e.g., from product category feature model type 402), as well as the particular feature values for the modeled product. Product model type 446 can include additional sub-model types in some instances, including product lifecycle models, product supply chain network models, product bill-of-materials (BOM) model types, etc.

Product models can be related, the relationships between models being defined in fields of the respective models. For instance, a product model in one organization can be related to a product in a different organization through a buy/sell relationship. For example, a retail organization can sell a product called “TV XYZ”. Meanwhile, a manufacturing organization can makes a product also named “TV XYZ” (i.e., the same product). These two products can each be modeled in different models as children of the models of the different respective organizations, but they are related to one another in that the retailer organization purchases its product from the manufacturer organization.

Organization model 320 can include additional sub-models including a supply chain activity model type 448 modeling transformation activities of the organization within the supply chain together with lead times estimated or associated with each transformation activity. A transformation activity can be any activity performed by an organization within the marketplace that changes the state of the good or service as it propagates through the supply chain, value chain or distribution channel, including its development state (e.g., manufacturing, assembling, etc.) as well as its locational state (e.g., shipping, receiving, procurement, distribution, etc.). Instances of supply chain activity model type 448 can represent a rough cut model of the resources and lead times associated with a particular market product category that an organization provides to the global market. In some instances, a supply chain activity model can define transformation activities performed by the organization within its various value chain roles within a market as well as average, estimated, or actual lead times associated with these particular transformation activities. In some instances, organization-specific data can be collected that can be used in a transformation activities and lead times model to define actual or assumed transformation activities known to be performed by the corresponding organization as well as organization-specific estimated or reported lead times of the activities. In other instances, where such data is less precise relating to the lead times of an organization's particular transformation activities, rough cut lead times can be estimated from available data for the organization and other entities and markets relating to a corresponding value chain role, market segment, or activity to thereby generalize transformation activities and/or lead times for a particular organization.

Instances of supply chain activity model type 448 can be provided for each activity performed by the organization within the global marketplace. For instance, an instance of supply chain activity model type 448 can be generated for a refrigerator manufacturer relating to the activities of the organization. Instances of the model can be provided for the organization including instances modeling, for instance, a one week average lead time to “manufacture” particular refrigerators and a two week average lead time to ship (or “distribute”) the product to a particular customer in a particular market region. Other refrigerator manufacturers and distributors can take shorter or longer to manufacture and distribute refrigerators, and perform other transformation activities. Further, lead times can be calendar- or demand-dependent, with lead times increasing, for instance during high-demand periods.

In the particular example of supply chain activity model type 448 of FIG. 4C, supply chain activity model type 448 can include attributes such as the type of activity (e.g., selected from a set of predefined transformation activities, such as procurement, manufacturing, distributing, etc.), the organization's product(s) to which the activity and lead time apply, the corresponding market product category, the associated (and in some cases estimated) lead time value and conditions, as well as other attributes such as supply chain costs associated with the activity. A supply chain activity model 448 can be used, among other examples, to assist consumers of global market model in identifying how a product propagates across a supply chain, for instance, to determine how demand changes in the market can then translate to potential demand changes across a supply chain. Indeed, each modeled activity can represent a link between inventory nodes (and respective inventory node models (e.g., 450)). In some implementations, the relevant supply chain activities can include “make,” “move,” “buy,” or “sell.” For instance, a “make” supply chain activity model links inventory node models for the components to the inventory node model for the manufactured product. The execution of a “make” supply chain activity results in a decrement to on-hand of each of the component inventory node models and an increment to the on-hand of the manufactured product. A “move” supply chain activity model links an inventory node for a product at one facility to an inventory node for the same product at a different facility. The execution of a “move” supply chain activity results in a decrement to the inventory node at one facility and an increment to the inventory node at the other facility, and so on.

Further, instances of an inventory node model type 450 can be provided in each instance of organization model 320. Inventory node models can represent stocking points for a product at a particular facility or across a group of facilities of the organization. The inventory node can be used to capture and encapsulate the way the product is handled in the facility, such as the inventory policy, safety stock policy, replenishment policy and so forth. An instance of inventory node model type 450 can further model actual or estimated on-hand of a product at a particular time at a particular facility. The inventory node model can have attributes and sub-models modeling and describing all aspects of the inventory node, inventory policies, and actual inventory including the safety stock policies, replenishment policies, and the supply chain network for replenishing this inventory node, the actual and estimated on-hand inventory by time period, and so on. For example, all of Company X's “3D TVs in the California USA Distribution Centers” can be sourced primarily from a Mexican manufacturing plant and secondarily from a manufacturing facility in Shenzhen, China. The attributes and sub-models of inventory node model 450 can be used, for instance, to additionally model the details of the distribution activity from the Mexico plant to the California distribution center, from the Shenzhen factory to California, among other details and examples.

As noted above, an inventory node model can model the actual or estimated inventory within an organization. The quantity or amount of inventory at various inventory nodes can be represented, for instance, as the number of weeks or months of inventory held by the organization, the number of inventory turns, etc. In some instances, data collected from various sources can provide organization-specific information and other clues (e.g., from filing statements and other filings) indicating the types and amounts of inventory typically held by a specific organization. In other instances, inventory model attributes can be based on data reporting or indicating averages, assumptions, or estimates across a value chain role within a market product category (e.g., when organization-specific inventory data is unavailable, outdated, etc.). Attributes and fields within inventory node model instances can define tendencies or patterns in the organization's inventory (e.g., seasonal inventory holds, etc.), and be used, for instance, to further model the effects of changes in demand across a supply chain (e.g., in connection with supply chain activity model 448) with inventory representing, for example, a potential buffer in the event of a sudden or unforeseen demand increase or representing excess production in the event of a demand decrease, etc.

Further, instances of organization model type 320 can also include instances of a facility model type 458. Instances of a facility model type 458 can model the respective physical facilities of the corresponding organization. Facilities of an organization can be of different types, stores, distribution center, factories, offices, test labs, etc., and these types can be modeled by facility model type 458. Further, instances of the facility model can include attributes and sub-models describing other aspects of the facility, including the facility's address, days and hours of operation, holiday calendars associated with the facility, the number of employees at the facility, etc.

FIG. 5D shows a simplified block diagram 500d representing the relation of facility models, inventory node models and supply chain activity models. For instance, block diagram 500d includes representations of facility models (e.g., 540-542), inventory node models (e.g., 543-551), and supply chain activity models (e.g., 552-564). The “Factory” facility model 540 contains “buy” supply chain activity models 552-554 modeling the purchase of component products, which are stocked in inventory node models 543-545. The inventory node models 543-545 are linked to “make” supply chain activity models 555, 556 which can represent the assembly of component products into products for sale by the organization, which are stocked in in inventory node models 546, 547. “Move” supply chain activity models 557-560 represent the movement of the products for sale to either of two distribution centers 541, 542. Inventory node models 548-551 represent the stocking of the products at the DCs 541, 542. Finally, “sell” supply chain activity models 561-564 represent the selling of these products either to other organizations or customers in the value chain of the market.

FIG. 4D illustrates a simplified block diagram 400d representing an example value chain role model type 327. A value chain role model type 327 can model value chain roles of particular organizations within each market product category. For example, a cell phone product category can include “manufacturers,” “distributors,” “carriers,” “retailers,” among other potential value chain roles. Different market product categories can have varying value chain roles. Similarly, a single organization can possess multiple different value chain roles. In some instances, a particular organization can play a first value chain role (e.g., retailer) within a first market product category and a different, second value chain role (e.g., distributor) in another market product category. Further, a single organization may play the same value chain role within many market product categories (e.g., a big box retailer selling a variety of different goods), or may play multiple value chain roles (e.g., manufacturer and distributor) within a single market product category. Accordingly, instances of a value chain role model type 327 can the various combinations of organizations and market product categories filling a modeled value chain role. Further, instances of a value chain role model type 327 can be used, for instance, in connection with the identification of value chain roles and channel partners up- and down-stream from another, particular value chain role (or organization possessing a particular value chain role), as well as other organizations sharing the same value chain role (i.e., competitors of the organization).

In the particular example of FIG. 4D, a value chain role model type 327 can be instantiated for each known value chain role in the marketplace. Such a model type can include sub-model types and attributes such as the value chain role name 424 and value chain role relationship model type 426. Instances of a value chain role relationship model type 426 can each define a particular interrelationship between the modeled value chain role and a particular organization within a particular market product category. Accordingly, each instance of a value chain role relationship model type 426 can model an instance of a particular organization playing the modeled value chain role within a particular market product category and attributes can define the relationship for the corresponding model instance. Such instances of value chain role relationship model type 426 can then be used to link organizations, value chain roles, and market product categories within the context of one or more value chains modeled using the global market model.

While the examples of FIGS. 3B and 4D illustrate a value chain role model type as a direct sub-model of the global market model 305, in other implementations, a value chain role model type can instead, or additionally, be a child or sub-model of other model types, such as market product category model type 310 and/or organization model type 320, thereby also defining the interrelationship between a modeled value chain role and market product categories within which the value chain role is played and the organizations playing the value chain role, among other examples.

Regardless of the implementation, value chain role model instances can further be used to model and define the relative relationships of one value chain role to another, depending, for instance, on whether one value chain role is upstream or downstream from another. Such relationships can be defined, for instance, in fields or sub-models of the model instance. As an illustrative example, FIG. 5E shows a simplified block diagram 500e representing the relationship of value chain roles within the value chain. For instance, a “Contract Manufacturer” value chain role (e.g., 510) can immediately precede a “Manufacturer” value chain role (e.g., 511), meaning that organizations that play the contract manufacturer role in the value chain for some market product category, make products that are then “sold” to organizations that play the manufacturer role in that same market product category. Similarly, the “Manufacturer” value chain role (e.g., 511) precedes the “Distributor” (e.g., 512) and “Retailer” (e.g., 513) value chain roles, meaning that organizations that play the manufacturer role in the value chain for a particular market product category sell products to organizations that play either the distributer role or the retailer role for that same market product category. Finally, the “Distributor” value chain role (e.g., 512) can precede the “Retailer” value chain role (e.g., 513), among other examples.

Further, in another example shown in the simplified block diagram 500f of FIG. 5F, a combination of one or more market product categories, one or more organizations, and one or more value chain roles (and their corresponding model instances) can serve to define a network that represents, at a high level, a value chain and how products flow through the value chain. In some instances, this can be accomplished without needing to reference specific products themselves. For instance, in the example of FIG. 5F, relations of market product category models, organization models and value chain roles are represented, an example value chain modeled, at least in part, through organization model instances 514-518, value chain role model instances 577, 578, and market product category models 593-595. For instance, an organization “TV Maker XYZ” (e.g., 516) can plays the value chain role “Manufacturer” (e.g., 577) in the market product category “LED-LCD Television” (e.g., 595). The organizations “Electronics Chain ABC” (e.g., 517) and “Electronics Chain DEF” (e.g., 518) can also be associated with the market product category “LED-LCD Television” (e.g., 595), but with a different value chain role (e.g., “Retailer” 578). Further, the organizations “Display Maker” (e.g., 514) and “DSP Maker” (e.g., 515) can also play the value chain role “Manufacturer” (e.g., 577), but in different market product categories (e.g., 593, 594). Additionally, in this particular example, the market product categories “LCD Display” (e.g., 593) and “DSP” (e.g., 594) can be components to the market product category “LED-LCD Television” (e.g., 595), and therefore products in the value chain will flow from “Display Maker” (e.g., 514) and “DSP Maker” (e.g., 515) to “TV Maker XYZ” (e.g., 516). Similarly, the value chain role “Manufacturer” (e.g., 577) can precede the value chain role “Retailer” (e.g., 578), and products can be determined to flow in the value chain from “TV Maker XYZ” (e.g., 516) to “Electronics Chain ABC” (e.g., 517) and “Electronics Chain DEF” (e.g., 518).

Turning to FIG. 4E, a simplified block diagram 400e is shown representing an example customer segment model type 328 included within the global market model 305. A customer segments model type 328 can include a model for defining the customers who buy, consume, or otherwise use the products (i.e., good and/or services) offered in the market. Customers can be consumers, other organizations, or any other entity downstream from an organization and consuming or otherwise using products supplied, sold, offered, or otherwise provided by the organization. For example, a television manufacturer may sell to “National Chains”, “Specialty Electronics Stores” and “Online Retailers”, which would be examples of organization customer segment models. A retailer of televisions and electronics may sell to “Upward Bound” and “Beltway Boomers” among others, such as defined end consumer customer segments (e.g., drawn from the Nielsen PRIZM™ customer segmentation system or other sources). The customer segments defined in customer segment model type 328 can vary from market product category to market product category, as well as from market region to market region. For instance, some customer segments may only be relevant or applicable to certain market product categories and certain geographic regions. In some instances, customer segments can be defined for groupings of customers, such as according to customer demographics and preferences. In some examples, customer segments for a market can be defined to include customer segments accepted or used across the respective product market. As with other models, individual organizations and customers of global market model 305 can choose to use those customer segments defined in instances of customer segments model type 328 or to supplement, substitute, or otherwise customize those customer segments to create customized customer segment hierarchies (e.g., in a corresponding organization-focused version of customer segments model 328).

Instances of a customer segment model type 328 can be used to model a specific customer segment that buys in one or more market product categories as well as the characteristics of the customer segment. Further, in some examples, customer segment models can be arranged in a hierarchy, where higher level customer segment models represent a broader classification of customer, and lower level models represent a narrower classification, etc. For instance, as shown in FIG. 5G, a simplified block diagram 500g is shown representing an example hierarchy of customer segment models. For instance, a customer segment model “Young Accumulators” (e.g., 520) is a parent to several other customer segment models (e.g., 521-525). Accordingly, returning to the example of FIG. 4E, instances of customer segment model type 328 can include one or more sub-model types including, for instance, a sub-segment model type 432 and segment relationship model type 434. A sub-segment model type 432 can be used, for instance, to model sub-segments of a customer segment, the sub-segment model type 432 inheriting the structure and attributes of customer segment model type 328 as well as defining a parent-child relationship between two customer segments (e.g., “Young Accumulators” and “Fast Track Families,” as in the example of FIG. 5F), to model hierarchical relationships between modeled customer segments.

Further, as customer segments can be defined by market segment (i.e., region-market product category combinations) as well as shared by multiple market different market segments, the relevance of a particular customer segment can be defined per region-market product category combination, thereby defining a relationship between the modeled customer segment, a particular region, and a particular market product category. Accordingly, instances of a segment relationship model type 434 can be used to model each market segment, or market product category and region, to which the customer segment applies, as well as the interrelationship between customer segment, region, and market product category. Further, in other implementations, the relationship or applicability of a particular customer segment to a particular region and/or market product category can be reflected by instead (or additionally) including a customer segment model type as a sub-model of a region model type and/or market product category type (e.g., rather than providing the customer segment model type as a direct sub-model of the global market model, as shown in the particular examples illustrated in FIGS. 3B and 4E).

In some implementations, instances of customer segment model type 328 can further include additional sub-model types such as a demographics model type 427. For example, instances of a demographics sub-model type 427 can be used to model demographics of the respective customer segment modeled in the instance of the customer segment model 328. Customer segments model 328 instances can further include attributes such as the name 429 of the customer segment, a description 439 of the customer segment, among other examples. For instance, a customer segment model type may optionally include attributes or provide sub-model types for defining actual named persons and/or organizations within a customer segment, among other examples.

As noted in the discussion of the example of FIG. 3B, an example global market model 305 can further include additional models, such as a market segment model type 326, as illustrated in the simplified block diagram 400f of FIG. 4F. A market segment represents the opportunities present within a subsection of the greater market to an enterprise. In some instances, a market segment can be considered to represent an intersection of a particular market product category, a particular market region, and a particular customer segment. Instances of a market segment model 326 can model all aspects of the distinct opportunity within the global market and what it takes to compete successfully for that opportunity. A market segment can be defined in terms of a specific market product category, a refined sub-set of a market product (e.g., based on a specific value or value range of an attribute of the market product category), a specific market region or set of regions where the product category is sold, a specific customer segment or set of customer segments who are customers in the market segment, and/or organization or set of organizations who are either direct or indirect customers for the particular market product category, among other example. In some instances, market segments can be considered the key battleground where products compete head-to-head. Two products that belong to the same market product category, but are not sold in the same market regions, may not be considered direct competitors because they do not share the same market segments. Similarly, two products in the same market product category and market region which target different customer segments may also not be direct competitors. One example of a market segment could be “Televisions of Screen Size >50”, USA region, consumer households with incomes >$50,000,” among potentially limitless other segments. Accordingly, instances of market segment model 326 can include constituent attributes and sub-models describing the exploitability of a particular market segment. For instance, in some implementations, an instance of a market segment model 326 can include attributes such as the name (e.g., 497) (or identifier) of the market segment, the market segment's customer segment (e.g., 493), market product category (e.g., 498), and geographical market region (e.g., 499). In some implementations, instances of market segment model 326 can further include sub-model types such as a market size forecast model type 494, market share driver model type 495, and market share forecast model type 495, among potentially other sub-models and attributes.

Consumers of the global market model and an associated global market intelligence system can utilize information concerning various market segments to make decisions related to how to enter, increase, or maximize their financial performance in the respective market segment. Instances of a market segment model type 326 can include attributes and sub-models to model and define the corresponding market segment opportunity. For instance, a market size model type 494 can be included that models the size of the opportunity. The market size forecast model type can be used to instantiate a plurality of market size forecast models, each market size forecast model belonging to a market segment model and representing an expectation of future sales in the market segment over a defined set of time buckets. Instances of market size model type 494, in some implementations, can contain data describing market size actuals and forecasts, for instance, as reported by various forecasters and reports and/or derived from market data obtained from other digital sources. Therefore, each market size forecast model can have a corresponding forecaster (either person, organization, or other source) responsible for generating and providing the forecast. Multiple market size forecast models may exist for the same market segment, representing different expectations of different forecasters. For example, one market size forecast model may be generated by a person in the Demand Planning department of an enterprise, while another market size forecast model is from a publicly available forecast released by a public market analyst. A market size forecast model may contain one or more forecast measures such as units, revenue and profit pool. The market size forecast model also contains the set of assumptions that were used in generating the forecast. Further, market size, whether actual or forecast, can be tied to a particular time periods (e.g., weekly, monthly, quarterly, over certain selling seasons, annually, etc.). Some market segments, based either on the inherent nature of the market segment itself or the quality of data obtainable for the market segment, may be limited in the different time periods for which market size data and forecasts are available. In some implementations, instances of market size model type 494 can further include attributes and sub-models describing the market size measurement, the relevant time period to which the market size measurement applies, the different time periods that are applicable to the market segment, the assumptions, analytics, methods, and sources of market size measurements and market size data used in the market size measurements, how the market size was measured (e.g., in terms of units, revenue, profit, etc.). Such attributes can be further used to measure and model the accuracy of forecasts and measurements of market size data for the market segment.

Instances of market segment model type 326 can further include instances of a market share driver model type 495 that models market share drivers for a particular market segment. Various product features and market characteristics can influence and effect the amount of market share enjoyed by each participant (or competitor) in a given market segment. For instance, price, particular product features, marketing exposure, and other factors can be considered “drivers” of market share for a market segment. Market share driver model type 495 can model and capture measurements and forecasts of the key drivers of share and their respective relative importance for a particular market segment. As an example, share drivers for a market segment relating to the Televisions product market category in the United States across all consumer segments for brand manufacturers can include competitive product differentiation, product portfolio variety, competitive price differential, brand awareness, product awareness, channel coverage, product availability, among others. The market share driver measures can additionally describe the relative influence of the respective, identified share drivers for the market segment. Market share driver predictions and data can be gathered from a variety of sources and account for the time period for which the market share measurements are relevant. Accordingly, instances of market share driver model type 495 can include attributes and sub-model instances that detail the market share drivers measures, time periods utilized in the share driver analyses, the different time period available for measuring share driver influence within a particular market segment, the assumptions and techniques (i.e., methodology) utilized to measure share driver influence, among others. In some implementations, instances of market segment model type 326 can further include a market share driver forecast model type is used to create a plurality of market share driver forecast models, each market share driver forecast model belonging to a market segment model and representing the key market share drivers and relative importance of each that is used to generate a market share forecast over a defined set of time buckets for a set of products competing in the market segment. Each market share driver forecast model has a specific forecaster who is responsible for generating the forecast. Multiple market share driver forecast models may exist for the same market segment. Turning to FIG. 5H, a simplified representation 500h is shown illustrating weights of various market share drivers of an example product. For instance, market share drivers can include product features (e.g., 567, 569, 570, 574, 575), marketing measures (e.g., 565, 566, 568, 571), channel measures (e.g., 572, 573), pricing measures (e.g., 576), as well as others.

Returning to the discussion of FIG. 4F, in some implementations, instances of market segment model type 326 can further include a market share driver forecast model type 497 used to create a plurality of market share driver forecast models, each market share driver forecast model belonging to a market segment model and representing the key market share drivers and relative importance of each that is used to generate a market share forecast over a defined set of time buckets for a set of products competing in the market segment. Each market share driver forecast model can have a specific forecaster identifying the source of the forecast. Multiple market share driver forecast models may exist for the same market segment.

Additionally, in some implementations of market segment model 326, instances of a market share forecast model type 496 can be provided that model and capture the market share actuals and forecasts (e.g., by units, revenue, profit, etc.) of each organization identified as competing within the particular market segment. Market share forecasts can be based on collected forecasts and measurement compiled and calculated by third-parties or can be generated themselves using market share data collected in connection with the global market model 305. Instances of market share forecast model type 496 can include attributes and sub-models describing the characteristics of the collected market share reports, forecasts, and data. For instance, the market share forecast results can be described in a share forecast attribute of the model 496 indicating the respective actual or forecasted percentage share of the market enjoyed by each of the identified organizations competing within the segment. A time period sub-model can model the time period to which the market share measurement applies, while a time period granularity model indicates the time periods that are relevant for the market segment and/or market share results. The sources, analytics, and overall methodology used to forecast the market share result can be modeled, for instance, in a methodology model, allowing for the characteristics of the market share results and forecasts to be assessed for accuracy.

Models and sub-models of market segment model type 326 can be interrelated with other models of global market model 305. For example, FIG. 5I shows a simplified block diagram 500i illustrating relation of an example market share forecast model and market size forecast model to example products and organization models. The organizations (e.g., 580-582) sell products (e.g., 583-586) in a particular market segment (e.g., 587). The market size forecast 588 for the market segment 587 for a particular time bucket, in this example, is 1,000,000 units. The respective market share forecasts (e.g., 589-592) for the four products, in this example, are 38%, 22%, 16% and 24% for that same market segment 587 and that same time bucket. Note that the total share across all products sums to 100%.

Model types, and thereby also model instances of a global market model 305 can be interrelated. These relations can be defined within the model instances themselves (e.g., through pointer fields and other relationship data) and exploited in the modeling of real-world market relationships and interdependencies. As an illustrative example, FIG. 4G shows a simplified block diagram 400g illustrating example relations between example model types in one example implementation of a global market model (e.g., 305). Indeed, as shown in the example of FIG. 4G, a single instance of a model type can point to multiple model instances of multiple model types. For instance, an example product model type (e.g., 446) can point to, encapsulate, or otherwise be related to other models of types such as a product group model type (e.g., 468), an inventory node model type (e.g., 450), an organization model type (e.g., 320), a market segment model type (e.g., 326), etc. commensurate with a real world product's association with one or more defined product groupings, one or more real world inventory nodes, one or more real world organizations (including the manufacturers, retailers, distributors, customers, etc. of the product), and one or more real world market segments in which the product competes, respectively. Other interrelations can also be defined as models and model types are added to the global market model and in accordance with the modeling of real world market relationships within the global marketplace.

While the examples of FIGS. 3A-5H illustrate a variety of constituent models, examples, and organization of one particular example implementations of a global market model 305, it should be appreciated that these are non-limiting examples, provided for purposes of illustrating certain general principles. Indeed, implementations of a global market model can include additional model types and interrelations between models not explicitly shown or described in the examples of FIGS. 3A-4H. For instance, a person model type can be provided that can be used to model and contain information about various persons participating in or relevant to the global marketplace. For instance, instances of a person model type could be used to model executives, leaders, owners, and other important figures of enterprises participating within the global marketplace. Further, additional query modules can be provided to be applied against the global market model to return market intelligence results to client queries. Indeed, the global market model 305 and query module library 310 should be considered to be extensible, with additional models and sub-models and query modules capable of being added substantially seamlessly to the overall global market intelligence system hosting the global market model 305 and query module library 310.

IV. Examples of Market Intelligence Provided through a Global Market Model

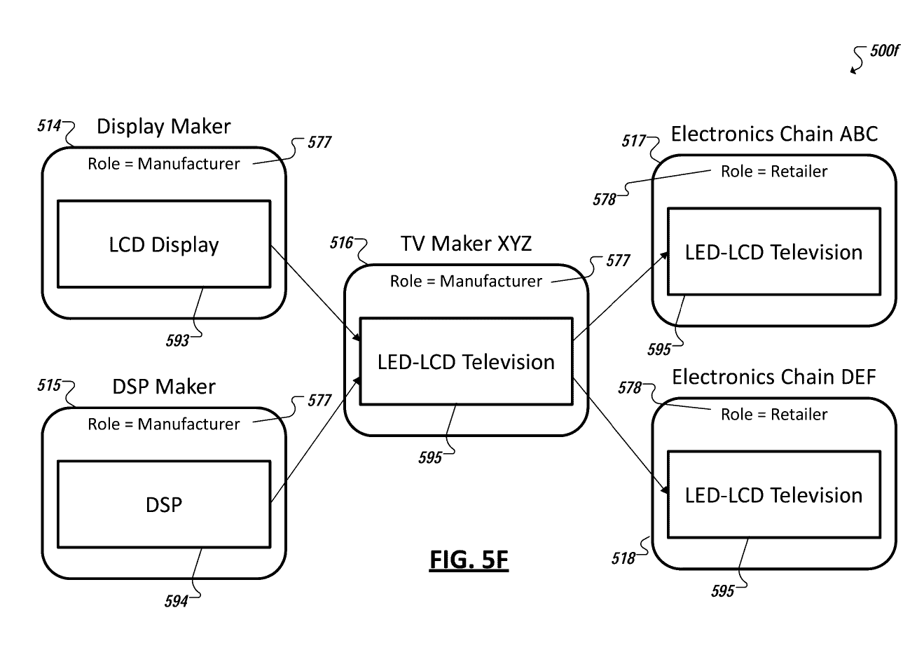

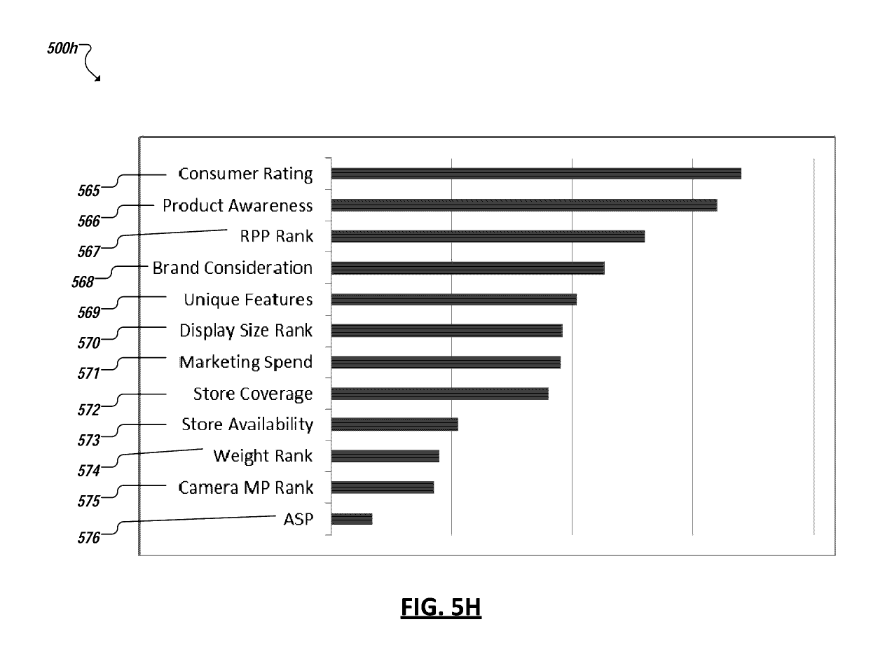

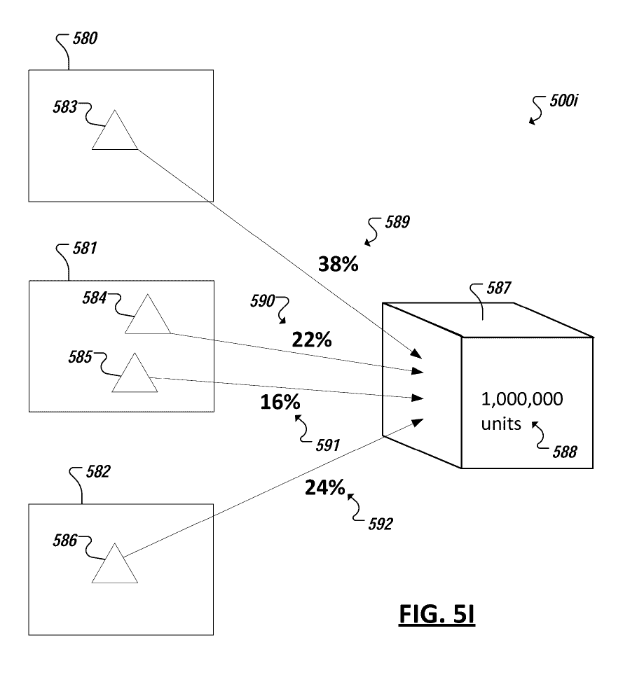

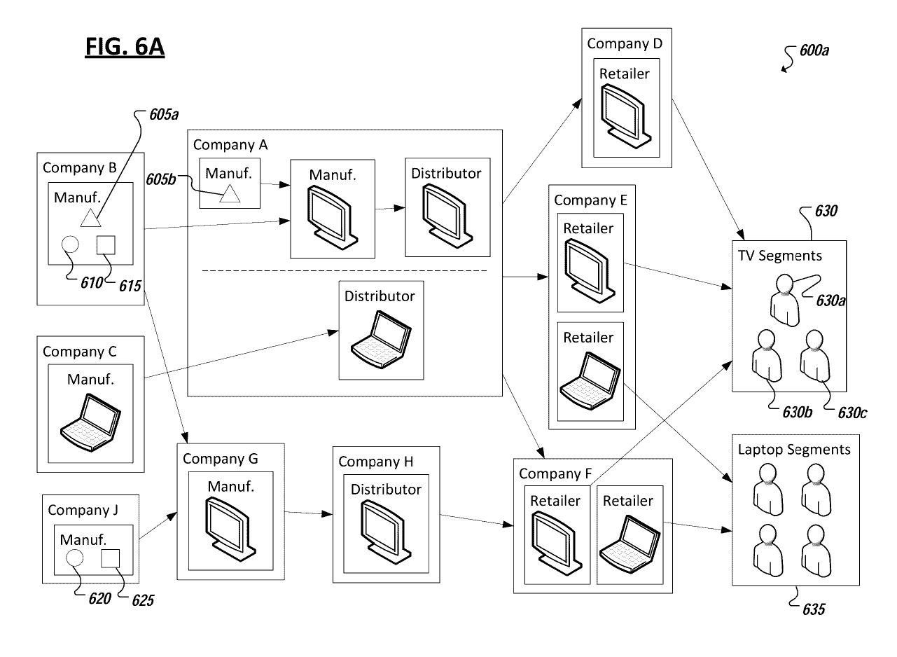

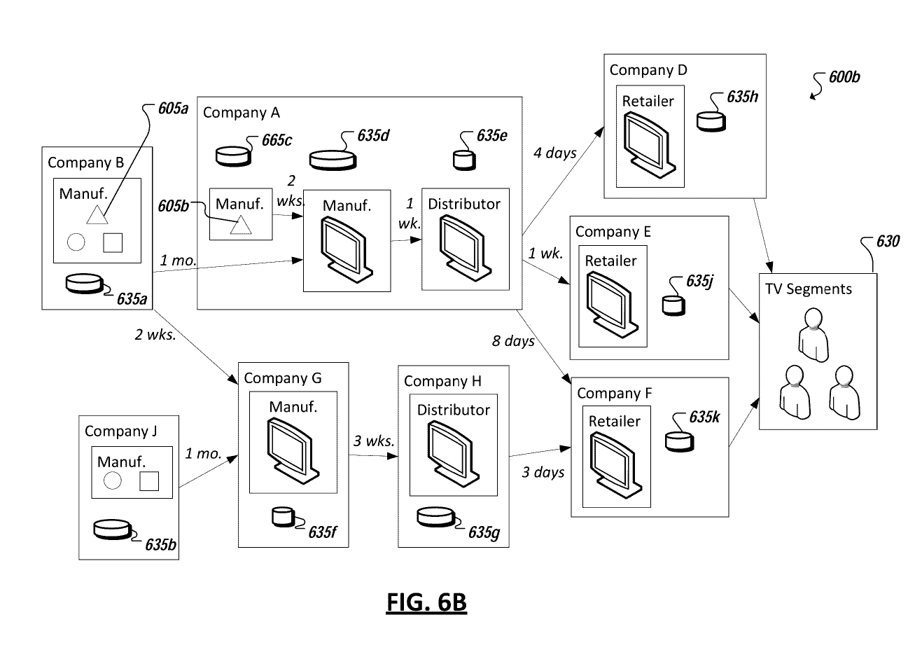

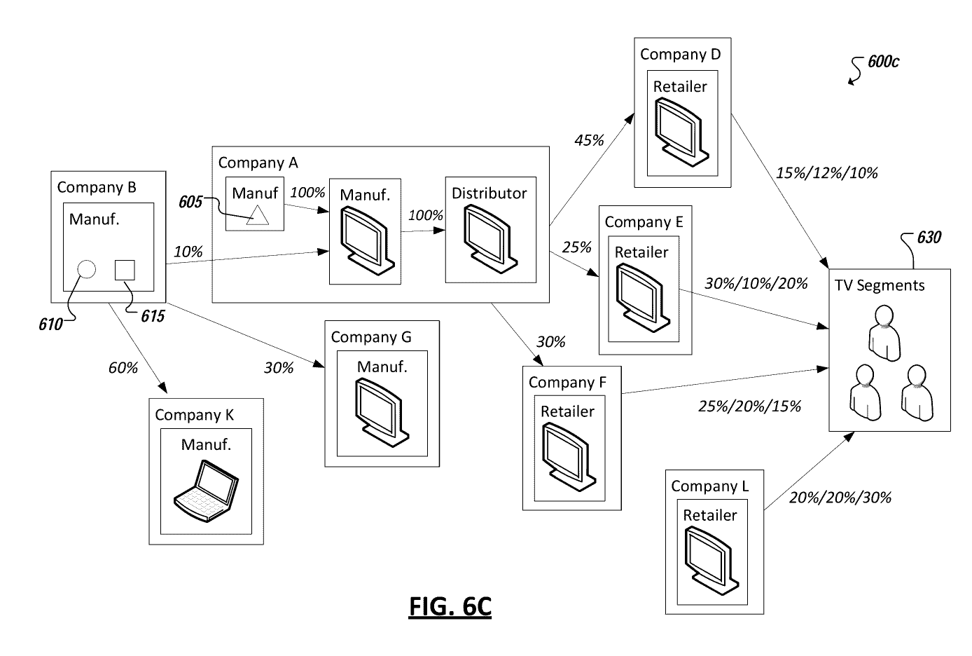

As noted above, model instances of model types included in a global market model can be instantiated to model organizations, roles, product categories, products, market forecasts, and other market features. Such model instances can then be used to determine answers to categories of market-related questions or requests. FIGS. 6A-6D represent the modeling of various example market and business scenarios capable of being modeled in an example global market model as well as example questions that can be asked against the global market model using various query modules (referred to herein interchangeably as “query modules” or “queries”). For instance, in FIG. 6A a simplified block diagram 600a is shown illustrating at least a portion of at least two value chains, a first value chain for a high-definition televisions (HDTVs) market product category and a second a value chain for a laptop computers market product category. A particular company, Company A is involved in both the HDTV market product category and the laptop market product category. As represented in FIG. 6A, Company A participates in the HDTV market as a manufacturer of parts (e.g., 605b) used in the manufacture of finished HDTVs, as well as the manufacturer and distributor of finished HDTVs. Company A is a customer of and consumes additional HDTV parts (e.g., 610, 615) from a supplier, Company B, and distributes finished HDTVs to three different retailers in the HDTV market, Companies D, E, and F, who sell to customer segments 630a-c of the HDTV product market in a particular region.

Company A can participate in multiple market product categories, as many modern global corporations do. For instance, in the example of FIG. 6A, Company A can also be a distributor of laptops manufactured by Company C. Company A can distribute the laptops to some of the same retailers used to sell Company A's HDTVs, such as Companies E and F. A different set of customer segments 635 (other than the customer segments 630 of the HDTV market product category) can be identified that consume goods in the laptop market product category.

Other organizations can also participate in the same value chain as Company A, but as a competitor in particular value chain roles. For instance, Company B is also a manufacturer of HDTV part 605a-b; Company G is also a manufacturer of finished HDTVs; and Company H is also a distributor of HDTVs. Organizations that have the same value chain role as Company A can be considered Company A's “competitors,” while organizations upstream or downstream from Company A are considered “channel partners,” if even as potential partners (e.g., HDTV part manufacturer Company J) within the value chain of a particular market product category.

Models of a global market model (e.g., 305) can be used to model the entirety of the relationships and value chains represented in FIGS. 6A-6D. Indeed, while some of the examples of FIGS. 6A-6D illustrate only a portion of a product category's value chain, the models of the global market model can be cross-referenced, linked, interrelated, or otherwise associated together to model the entirety of those participants, products, activities, and relationships known within one or more product categories. As an example, in FIG. 6A, instances of an organization model (e.g., 320) can model each of Companies A-J, and instances of a value chain role model (e.g., 327) can model each of the value chain roles (e.g., component/part manufacturer, product manufacturer, distributor, retailer, etc.) for each of the HDTV and laptop market product categories. Indeed, a market product category model (e.g., 310) can be instantiated (identified or generated) for each of the HDTV and laptop market product categories. Further, instances of a customer segment model type (e.g., 328) can model customer segments 630a-c, 635, etc. pertaining to the respective market segments of HDTV and laptop market product categories, in particular geographic regions. Further, the geographic market regions and sub-regions in which the activities and markets illustrated in FIG. 6A take place, can also be modeled, for instance, through instances of a market region model type (e.g., 315), among other examples.

Continuing with the discussion of the examples of FIG. 6A, in one particular example, a user, organization, or other client of a global market model (served, for instance, by a global market intelligence system or engine) may desire and request market intelligence relating to Company A's place within the HDTV and laptop markets in Canada. A variety of model instances can be generated (e.g., from the global market model's inherent data) or identified (e.g., from pre-instantiated models) within the global market model in response to this request. For instance, an instance of an organization model type (e.g., 320) can be identified for Company A. Further, instances of a market product category model type (e.g., 310) can be identified for each of the HDTV and laptop product market categories, and market region model instances (e.g., 315) can be identified for Canadian market regions. In still other examples, a market segment can be defined for either (or both) of the HDTV and laptop markets in Canada over a particular time period and a corresponding instance of a market segment model (e.g., 326) can be identified in connection with responding to the request for market intelligence. Further, one or more instances of a value chain role model (e.g., 327) can also be identified, for instance, corresponding to value chain roles identified for Company A in the HDTV and laptop market product categories, among other examples.

In one illustrative example, an organization model instance (e.g., 320) or value chain role model instance (e.g., 327) corresponding to Company A can include information identifying the market product categories in which Company A participates (e.g., via product sub-models (e.g., 446) of the instantiated organization model (e.g., 320)), including the HDTV and laptop product markets, as well as the Company A's roles within the respective value chains (e.g., that Company A is both a parts manufacturer, finished product manufacturer, and distributor of HDTVs as well as a distributor of laptop computers). Still further, instances of organization model type (e.g., 320) and/or market segment model type 326 can indicate that Company A is active in the HDTV and laptop markets in Canada.

Continuing with the previous example, information gleaned from instantiations of an organization model type and/or value chain role model type for Company A can be used to instantiate other global market model sub-models. For instance, identifying value chain roles of Company A relative to Company A's participation within the HDTV and laptop markets in Canada can prompt the identification of other organization models within the same (or related) value chains. For instance, a search of other value chain role model instances, market segment model instances, and/or organization model instances (or inherent data of the global market model itself) can lead to the identification of other organizations (and corresponding instances of the organization model) participating within the value chains of each of the HDTV and laptop markets in Canada. Further, customer segments can be identified that pertain to HDTV and laptop markets in Canada and instances of the respective customer segment models can be identified.

The various market product categories, organizations participating in the market product categories and/or market regions, as well as market segments can be identified from information gleaned from one or model instances of a global market model. For example, instances of a market product category model can be generated or identified for each of the HDTV and laptop product markets and information included in these model instances can be used to prompt instantiation of other models (e.g., organization models, product models, customer models, organization share split models, etc.) to complete or supplement the modeling of the value chain for each of the product categories in Canada, among other examples.

With the models of global market model (e.g., instances of an organization model type, market product category model type, market region model type, market segment model type, value chain role model type, customer segment model type, and their constituent sub-model types) instantiated, identified, and available to model the value chains of HDTV and laptop product markets in Canada (e.g., as represented in the example of FIG. 6A), various questions can be answered with regard to the modeled value chains. For instance, questions relating to identification and characteristics of channel partners within the modeled value chains can be answered using one or more query modules (e.g., channel partners query module 335). Indeed, in some instances, execution of particular query modules can, themselves, cause the identification or instantiation of one or more model types for use by business logic included in the query module. Using model instances modeling aspects of the value chain illustrated in the example of FIG. 6A, a question concerning which other organizations are upstream or downstream from Company A within the value chains can be answered. Further, more-specific questions regarding Company A's suppliers (e.g., using value chain suppliers query 345), competitors (e.g., using organization competitors query module 392), as well as regarding all competitors within a particular market product category (e.g., using category competitors query 340) can be answered based on information included in the instantiated models. For instance, from the instantiated models, other organizations can be identified that share the same value chain role(s) as Company A (i.e., Company A's competitors) within either or both of the HDTV and laptop product categories (e.g., using business logic provided through category competitors query 340).

Identification of particular value chain partners, suppliers (actual and potential), and competitors can lead to additional intelligence being available and delivered to an inquiring client of the global market model. For instance, additional data (e.g., including otherwise publicly-available information) can be returned describing one or more organizations identified as a value chain partner, supplier, or competitor of Company A. Further, additional actions can be performed relating to intelligence returned in response to a request of the global market model. For example, an organization can identify (e.g., using the global market model and a value chain suppliers query) potential suppliers that the organization may choose to further investigate or contact. To assist in this, a feed can be created for or subscribed to by the organization in response to identifying particular market intelligence returned from the global market model. The feed can pull, push, stream, or otherwise report data and information relating to the subject of the feed (e.g., the potential suppliers). Such feed data can be served, in some instance, by the global market model in connection with such data being discovered and added to the global market model, for instance, from publicly-available resources on the Internet. In other examples, results from the global market model can be communicated to other models (such as enterprise-focused models) or other programs capable of using the returned data.

FIG. 6B is another representation 600b of a modeled value chain of a particular market product category. In addition to modeling the value chain roles, customer segments, and organizations participating in the value chain, activities performed within the value chain, together with time lapses associated with these activities, can be modeled within the modeled value chain. For example, instances of a supply chain activity model type (e.g., 448) can be generated or identified that model particular transformation activities at each link in the value chain (or activities performed by particular organizations in the value chain). As noted above, a transformation activity can be understood to include activities performed at a particular value chain role in order to move the development of the product down the supply chain. For instance, a manufacturer in a supply chain can perform a transformation activity that includes manufacturing a product, part, or component, and transporting the manufactured good to the next stage in the value chain. Similarly, a distributor in a value chain can perform a transformation activity relating to the delivery of a finished product to a retailer, among other examples. Further, a lead time can be defined for each transformation activity indicating the length of time it takes to typically perform the transformation activity. Such lead times can be based on actual, reported lead times of value chain role players and organizations, or can be estimates of lead times, determined or assumed as typical for a corresponding value chain role or a particular organization. Actual or generalized lead time values (and model instances) can be based, for instance, on publicly-available information collected in connection with the global market model that suggests particular average lead times associated with a particular transformation activity in a supply chain of a particular market product category.

By modeling transformation activities and lead times, propagation of goods and services from one end of the value or supply chain to the other (i.e., to the consumer) can be modeled. Further, events within the value chain can be modeled based on the modeled value chain propagation, for instance, to forecast the effects of a given event along the value chain. Further market intelligence can be modeled in the value chain, for instance, to forecast effects of demand changes within the value chain. In some implementations, one or more instances of an inventory node model type (e.g., 450) or other inventory-related models can be generated or identified for one or more of the value chain roles or organizations participating in a particular market category indicating typical, average, or actual inventory held by organizations at each point in the value chain (e.g., represented in FIG. 6B as elements 635a-k, with relative size of the element representing the relative amount of the inventory assumed to be held at each point in the value chain). Such inventory-related models can model typical inventory for generic value chain roles as well as actual or average inventory of a particular organization. Inventory-related models can utilize publicly available information to define an assumed amount of inventory at one or more roles or organizations in the value chain.

With inventory, transformation activities, and activity lead times modeled on top of the model of the value chain, demand changes within the value chain can be modeled and categories of questions answered (e.g., using logic of a demand change query module (e.g., 350)). For instance, a question or request for market intelligence relating to the effect of a particular news event or other information indicating an actual, predicted, or hypothetical increase (or decrease) in demand can be answered based on the modeled value chain, transformation activity and lead times within the value chain, as well as modeled inventory among participants in the value chain. For instance, a demand change downstream from an organization in the value change can be modeled to show that inventory held by the organization, or channel partners upstream from the organization, will likely be inadequate to handle the demand, among other examples and scenarios.

To illustrate, in the particular example of FIG. 6B, Company A can manufacture HDTV part 605b and a lead time of two weeks can be defined or assumed (e.g., from data captured from digital resources in connection with development of the global market model) for the manufacture of HDTV part 605b. Further, assembly and manufacture of the finished HDTVs by Company A can be associated with a corresponding lead time of one week. Additionally, Company A's distribution of finished HDTVs to various retailers (e.g., Companies D, E, and F) can vary from four days to one week, based, for instance, on the distance and type of delivery method used to transport the televisions to each respective retailer. Other transformation activity lead times can be defined and modeled for other organizations and activities within the modeled value chain. As noted above, the instantiation of some models, such as market product category and organization models, can be used to identify information for use in instantiating additional, related models in the global market model. Indeed, upon identifying the various organizations, products, and/or value chain roles within a particular market product category or, more generally, within a particular value chain, corresponding instances of activity- and inventory-related models (e.g., supply chain activity model 448, facility model 458, and/or inventory node model 450) can be generated or identified to model the activities, lead times, related facilities, and inventory across the value chain.

Continuing with the previous example, a consumer of the global market model may inquire regarding the inventory and delays associated with potential suppliers of Company A. Such an inquiry can be based or reference an anticipated or hypothetical demand increase, for instance, within customer segments 630, indicating an opportunity for Company A to increase its production of HDTVs and a likely increased demand for HDTV parts by Company A and its competitors (e.g., Company G). The inquiry can be interpreted and corresponding business logic identified (e.g., as embodied in a demand change query module 350) that can identify or instantiate instances of relevant model types (e.g., instances of organization model type 320, supply chain activity model 448, inventory node model 450, value chain role model type 327, etc.) and be applied against these identified model instances. Market intelligence can be returned, for instance, by executing logic of a demand change query (e.g., 350) in response to the query, the market intelligence indicating, for instance, the organizations affected by the demand change, as well as the respective inventories of these organizations, including current (e.g., Company B) and potential (e.g., Company J) suppliers, the enterprises most affected by the hypothetical demand change, as well as lead times associated with each supplier organization, etc. This intelligence can be used, for instance, to suggest that Company A will be affected by the demand change and that locking-up or requesting additional parts from upstream suppliers can potentially mitigate negative effects of the change, given information identifying available inventory and the potential delays associated with suppliers playing catch-up to make-up for unexpected demands on their inventory (e.g., 635a, 635b). A variety of other information can also be returned in response to questions concerning demand changes (i.e., increases or decreases) within a value chain, and such information and intelligence can assist consumers of a global market model in better anticipating and reacting to potential changes in the marketplace.

Turning now to FIG. 6C, other types of questions (e.g., handled by corresponding queries (e.g., 330)) can be applied against models instantiated in connection with the example value chain portions and market segments discussed and illustrated in connection with FIGS. 6A and 6B. Further, additional global market model sub-model types can be instantiated (identified or generated) to uncover and deliver additional market intelligence to consumers of the global market model. In the example of FIG. 6C, one or more instances of a market segment model type (e.g., 326) of global market model (e.g., 305) can be identified in connection with a request for market intelligence from the global market model. Various models can be provided through global market model 305 including forecasts and measurements of market share splits within the value chain of a market segment over a particular time period. For example, instances of a market share forecast model type (e.g., 496) can be instantiated for market share measurements of a particular market segment (e.g., a market segment modeled by a market segment model 326). Such models can capture or define actual, estimated, forecasted, or assumed market shares of various competing organizations, product categories, and products within the market segment, and can be further used to derive the split of a particular organization's output or demand within a related value chain. In other instances, model types can be provided in the global market model that more explicitly model such output (or input) splits within particular market segments. In either instance, such market intelligence (and corresponding market share model instances) can supplement other market intelligence for the value chain, including value chain propagation intelligence provided, for instance, in the modeling of demand effects discussed in connection with FIG. 6B.

As an example, as represented in FIG. 6C, Company B is a manufacturer and distributor of parts 610 and 615 (such as glass panels, liquid crystal displays, HDMI ports, etc.) that can be used in multiple markets, such as in both the production of HDTVs (e.g., by Companies A and G) and laptops (e.g., by Company K). Further, Company B can supply these parts to multiple customers within a particular product category's value chain. For instance, Company B can supply parts 610, 615 to both Companies A and G. Model instances modeling market share splits involving Companies A, G, and K (e.g., instances of market share forecast model type 496) can be identified that indicate or include information that can be used by query modules to derive what percentage of their respective supplies is provided by Company B. This percentage can, in turn, be used to calculate the percentage or portion of Company B's output consumed by which organizations, market product categories, etc. In other examples, instances of market share split models can further indicate what share of the market Company B enjoys in each of the market segments for parts 610 and 615, among other market-share-related market intelligence.

In the present example, one or more example instances of a market share-related model can indicate or forecast (e.g., based on data collected in connection with the global market model) that 10% of Company B's output is consumed by Company A, 30% by Company G, and the remainder by Company K. Further, it can be identified that 40% of Company B's output for parts 610 and 615 goes to the HDTV market product category, while 60% goes to a market product category for laptops. Questions and market intelligence requests can be answered based on the modeling of share splits within the global market model (e.g., through models 495, 496), relating to how a change in demand can effect supply (e.g., if demand increases in another market, such as the laptop market, making parts 610, 615 more difficult and/or expensive to secure within HDTV markets), as well as other questions relating to market share, such as products' (and thereby organizations′) market share performance (e.g., using share-winning products query module 396), identification and rating of various market share drivers' contribution to market share (e.g., using share drivers ranking query module 370 and/or share driver comparison query module 398), among other examples.

As further shown in the representation 600b of FIG. 6C, market forecast modeling and/or share split modeling in connection with the modeling of a value chain can also indicate the market share enjoyed by a particular market participant, including the market share across certain customer segments, among other examples. In the particular example of FIG. 6C, the modeling of a portion of an HDTV value chain indicates that Company A distributes finished HDTVs to retailer Companies D, E, and F. Further, share splits within the value chain can be derived or identified from the global market model to further indicate what portion of the market share of a particular market segment is enjoyed by each of Companies D, E, F, and L with regard to three identified customer segments 630a, 630b, 630c in the HDTV market product category. For instance, Company A distributes 45% of its HDTVs to Company D for sale. Company D, however, only enjoys 15% market share within a first customer segment, 12% market share within a second customer segment, and 10% market share within a third customer segment, while other retailers, such as Companies E and F enjoy better success in these customer segments. Further, other potential retailers can be identified with better market share that are not yet distributed to by Company A, such as retailing Company L. Based on intelligence gleaned from a global market model, its constituent models and data, answers to particular market-related questions can be answered, such as opportunities to better channel products to a particular customer segment (e.g., by selling fewer products through retailing Company D and instead enlisting or diverting supply to other retailers such as Company L), among a multitude of other examples given the robust data and relationships defined and maintained in the global market model.

FIG. 6D represents additional market intelligence that can be modeled by a global market model. In the representation 600d of FIG. 6D, competing products in a particular product market, market region, or other market can be modeled using a global market model. For instance, as represented in FIG. 6D, product modeling can be used to generate comparisons and answer questions relating to the comparison of competing products and their respective features, including features identified as important or measurable share, price, and/or cost drivers for products within one or more particular market segments. As an example, continuing with the consideration of an example HDTV market product category, models can be instantiated from a global market model to model aspects of a particular market and value chain, including organization models, market region models, market product category models, market segment models, etc. Other models and sub-models of the instantiated models can also be instantiated, such as a product model type (e.g., 446) of the organization model type (e.g., 320), a product category features model type (e.g., 402) of the market product category model (e.g., 310), a value range model type (e.g., 414) of the product category feature sub-model (e.g., 402), a market share driver model type 495 of a market segment model (e.g., 326), a market share forecast model type (e.g., 496) of a market segment model (e.g., 326), a market share driver forecast model type 497 of a market segment model (e.g., 326), and so on. Competitors within a value chain and/or products within a market product category or market segment can be identified from the instantiated models to identify a set of competing products within one or more real world markets. Further, models of the features and feature values of the respective competing products can be instantiated to obtain information relating to the respective features, market share drivers, and market share driver strength of the competing products for use in answering questions and responding to requests for market intelligence comparing the identified products.

In the particular example of FIG. 6D, competing products are identified for a variety of competitors within an HDTV market (including particular regional markets for HDTVs). Data collected and inherent in the global market model identifying particular products and describing corresponding features of the products can populate instantiated market segment, product and product feature models to model the competing products and share drivers. As represented in FIG. 6D, share drivers can be identified for products within a market segment such as product differentiation, price, customer awareness of the product's brand, customer awareness of the product, market channel coverage for the product, product availability, and so on. Particular features of the product can also, or alternatively, be identified as market share drivers such as price, total output power, contrast ratio, refresh rate, and other HDTV-specific product features. Each share driver can for a product within a market segment can have a related score or value that can be considered in determining the relative influence of particular market share drivers when considered against the market share (or market share rank) of the product within the market segment. Such features and values can be defined in (or derived from attribute values of) corresponding model instances identified for the market segment and related products. Further, in some instances, various queries can be run against this intelligence, such as though an example competitive landscape query module (e.g., 355), product competition query module (e.g., 360), share-winning products query (e.g., 396), share driver comparison query (e.g., 398), and others including logic for processing such product-, product feature-, and market share-driver related requests.

While the examples of FIGS. 6A-6D provide examples of questions that particular query modules can interpret, respond to, and answer (from a corresponding global market model (e.g., 305)), additional questions and queries, including more nuanced, complicated, and particular questions can be serviced by query modules in a library of query modules, each query module including (or accessing) business logic for handling one or more categories of question types in cooperation with the global market model. As an example, a channel partners query (e.g., 335), market product category competitors query (e.g., 340), or value chain suppliers query (e.g., 345) can each handle and provide responses to market intelligence requests and questions formulated for their respective category (channel partners, competitors, and suppliers), including requests for identifying other organizations in various regions and product categories, organizations sharing particular customers, organizations ranked according to their performance in a particular market segment, organizations sharing particular organizational structures, among other examples. For instance, a question can be responded to using a share-winning products query module (e.g., 396) and global market model (e.g., 305) requesting identification of the top five suppliers of guitar strings to a particular guitar manufacturer or to any guitar manufacturers located in one or more particular market regions (e.g., Brazil and Argentina), etc. Another question can be responded to that requests identification of customer organizations of all sparkplug manufacturers within Europe, while still another question can be responded to that requests identification of all organizations competing within China as retailers of basketballs. Indeed, each of these various example questions (and more) relating to the organizations and products competing within various market segments can be answered from the same global market model (e.g., 305) and the same re-usable set of query module logic (e.g., provided, in these examples, through various query modules of a library of query modules (e.g., 330), for instance).

Other query modules can utilize the same global market model (e.g., 305) to answer still more types of questions. For instance, a demand change query (e.g., 350) can answer questions concerning how a particular increase or decrease in demand within one or more particular value chain links can affect other links in the value chain (e.g., as illustrated in the example of FIG. 6B above). Such questions can vary, for instance, according to the market region, product category, market segments, etc. of the value chain. Further, a demand change query (e.g., 350) can also answer questions regarding the effects of a demand change to one or more particular organizations, as organizations can have their own specific lead time and inventory attributes affecting the individual organizations' respective sensitivity to demand changes. For example, a question can ask how an increase in demand for a bicycle brake manufacturing company, Company X, will (likely) affect two different bicycle assembly companies, Company Y and Company Z. Such a question can be further restricted to the effect on Company Y's and Company Z's respective businesses within a particular region of the bicycle market category, among other examples.

Further, query modules relating to the comparison of products and product features within one or more markets can be answered using one or more of a competitive landscape query (e.g., 355) and/or product competition query (e.g., 360). For instance, as in the examples above, specific attributes or various markets can be named in a question and be interpreted and answered to provide a listing of corresponding products offered in a matching market. As an example, a question can be answered using an example competitive landscape query (e.g., 355) requesting identification of each product competing in the smart phone retail markets of both the United States and China. In another question (e.g., answered using product competition query (e.g., 360)), particular features (e.g., price, technical specifications, size, weight, etc.) of products and values for those features can be named in a question requesting identification of products including those features competing in a particular market product category within the Austrian regional market (or a plurality of different market product categories and/or a plurality of different geographical regions). Additionally, questions can be answered relating to market size of particular market segments (e.g., using a market size forecast query module (e.g., 365) applied against one or more instances of a market size forecast model type (e.g., 494) included in a market segment model (e.g., 326) instance), among other examples. In short, through an extensible library of query modules and an extensible global market model aggregating market intelligence of the global marketplace, a potentially limitless variety of questions, including questions requesting market intelligence relating to very particularly defined market segments, organizations, etc., can be interpreted, understood, and returned.

V. Sample User Interfaces of an Example Global Market Intelligence System

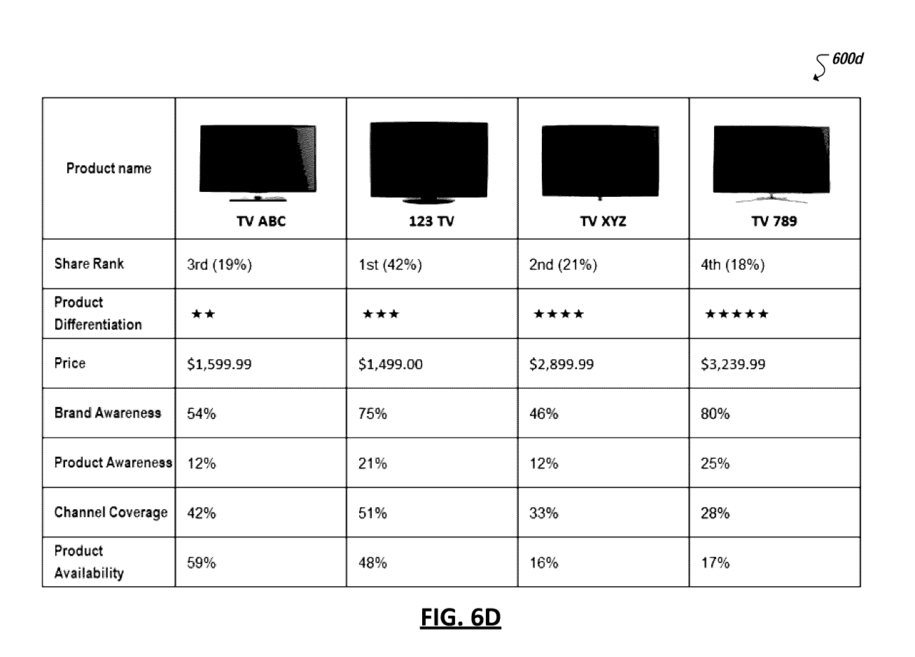

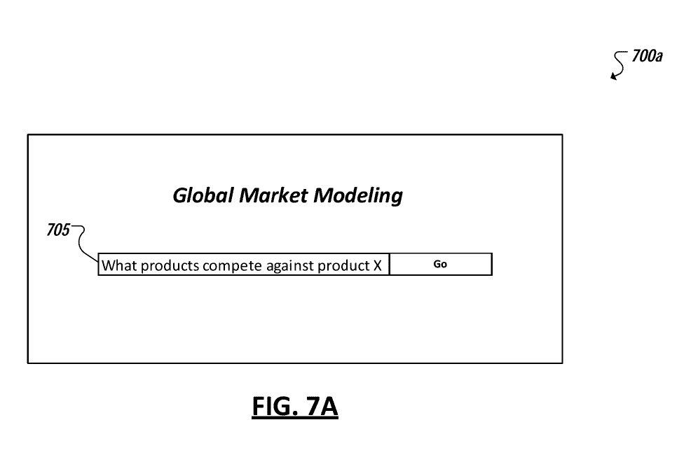

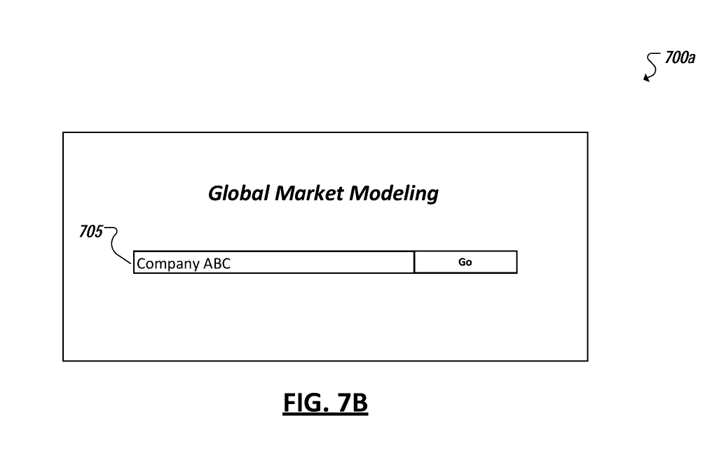

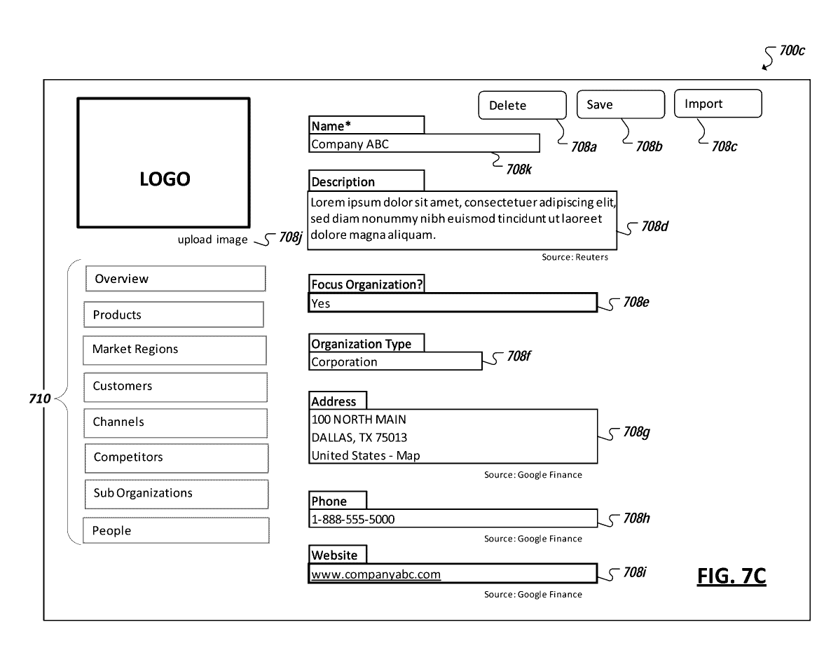

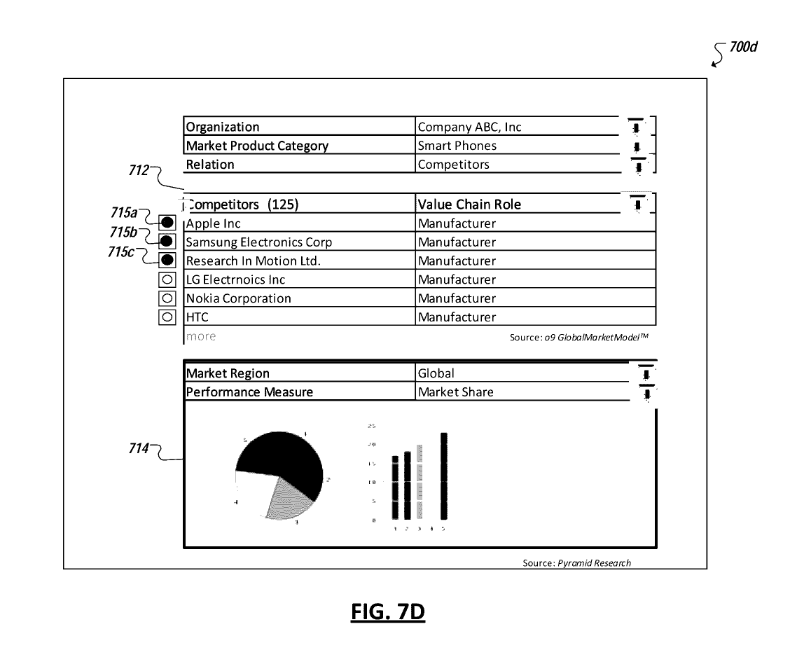

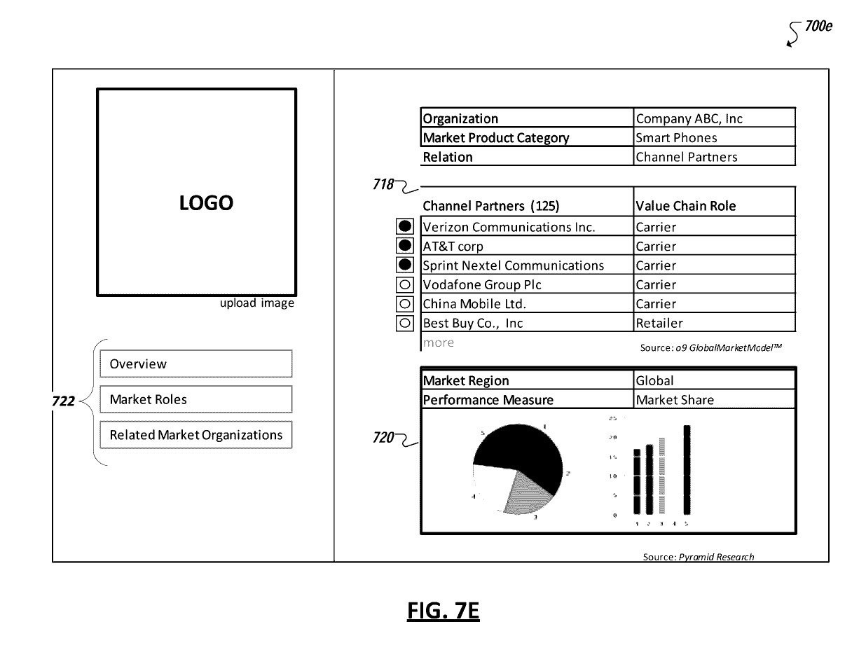

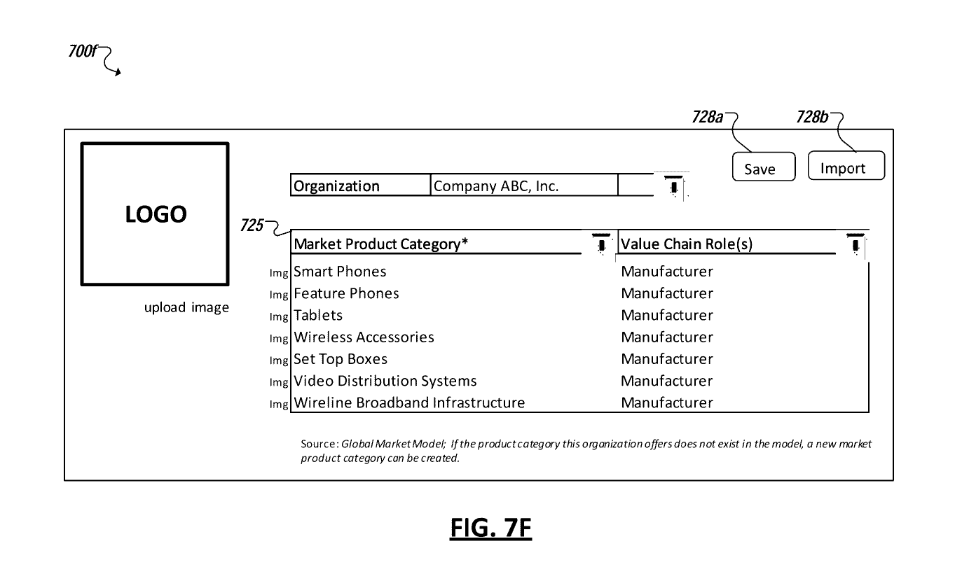

FIGS. 7A-7H illustrate screenshots of example graphical user interfaces for use in connection with an example global market model (e.g., 305). Beginning with FIG. 7A, a user interface 700a is presented for accepting a user input, such as a request for market intelligence, a question relating to aspects of one or more markets, query, or other requests of the global market model. In the example of FIG. 7A, a natural language question or request is entered in field 705. A global market intelligence system, such as a query engine, can interpret the natural language request to identify or instantiate one or more models of global market model relating to the substance of the request. The request or question (e.g., at 705) can be further parsed to identify and apply business logic from one or more relevant queries in a query library (e.g., 330) to the related, instantiated models. Additionally, the business logic of the queries can, themselves, identify related, instantiated models upon which to apply remaining business logic. In either instance, the natural language request can be parsed to generate a structured expression for use by the identified business logic to thereby generate and return a response to the input (at 705).

As an example, upon entering natural language input “What products compete against product X” (as shown in FIG. 7A), a query engine can process the input to recognize the reference to Product X and further determine that the input relates to a question concerning competing products. In response, and based on the interpretation of the natural language input, business logic can be identified (e.g., embodied as a corresponding query module or inherent in the global market model itself) and a structured expression can be generated, the structured expression including, in some implementations, at least one filter expression and, in some cases, the identification of at least one model type instance (such as in at least some of the example query modules of Table 2 above). The identified business logic can take the structured expression as an input, identify instances of model type(s) likely including responsive market intelligence, and interrogate or mine the identified model instances according to the filter expression to generate results responsive to the natural language request.

As an example, interpretation of the nature language input 705, can cause a competitive product landscape query module (e.g., 355) to be identified and invoked based on an interpretation of the natural language input and a suitable structured expression (e.g., identifying Product X) can be further generated based on the natural language input. Model instances of the global market model that model one or more related market product categories, organizations, product features, product model instances, etc. can also be identified that are associated with Product X or are a parameter of the identified query module. For example, a competitive product landscape query module 355 can accept as parameters the identification of one or more market segments (and corresponding instances of market segment model 326) as well as a filter expression (e.g., identifying Product X). Additional model instances can also be identified, for instance, through the execution of the query module, such as a product model type (e.g., 446), organization model type (e.g., 320), market product category model type (e.g., 310), and/or product category feature model type (e.g., 402), among other model instances relating to Product X, the market segments) it competes in, and the other products in these market segments. Business logic of the identified query module can be further applied against the identified model instances to identify market intelligence from the model instances that relates to the subject of the input, namely, the identification of products that compete with Product X. For instance, built that identifies one or more market segments identified for Product X. Results generated by the query module in response to the request input can then be returned to the user, for instance, through a graphical presentation of the results (e.g., listing the identified competing products along with attributes describing features and characteristics of the product (e.g., price, name, manufacturer, product features, etc.), an image of each product, etc.). In other instances, result data can be returned in response to the request (at 705) for further processing, rendering, and/or storage by another system or program consuming market intelligence and data returned from the global market model. In some instances, query results can include pointers to the model instances identified and used by the query module in the generation of its results (e.g., pointers to instances of a product model for each identified, competing product of Product X).

FIG. 7B includes another example of user interface 700a. In this example, a name of a particular organization, “Company ABC,” is entered in field 705. Results can be returned relating to market intelligence and models in global market model relating to or referencing Company ABC. In some instances, the input “Company ABC” can trigger the identification and execution of one or more query modules as well as the identification or instantiation of models relating to Company ABC, such as an instance of an organization model (e.g., 320). Further, options can be provided to enter or provide additional data (or edit existing information) relating to Company ABC for collection and use by the global market intelligence system in connection with maintenance of the global market model.

Additional user interfaces can be provided to view and/or edit data underlying market intelligence returned from the global market model by a global market intelligence system. For instance, in FIG. 7C, a graphical user interface 700c can be returned in connection with results generated by an input “Company ABC,” such as entered in the example of FIG. 7B. The GUI 700c of FIG. 7C can include a presentation of an overview of Company ABC, based on information and intelligence included in the global market model. A user can simply view the returned information or, in some instances, when the user is so authorized and/or authenticated, utilize the GUI 700c to modify or add information to the global market model relating to Company ABC (e.g., via fields and controls 708a-k). For instance, a user can import (e.g., using control 708c) a description of the company from an outside source, such as an outside website, to populate field 708d. Further, in some instances, controls 710 can be used to present additional views of information describing Company ABC. The selection of one or more controls 710 can further instantiate or trigger the identification of instances of models corresponding to particular aspects of Company ABC. For instance, selection of a “Products” control can instantiate or otherwise access one or more product models (e.g., 446) for Company ABC. Further, selection of certain controls 710 can also trigger the utilization of queries in a query library (e.g., 330), such as the selection of a “Competitors” control triggering the use of an organization competitors query (e.g., 392) to instantiate models in a value chain and identify competitors of Company ABC from the instantiated modeling of the value chain.

Turning to FIG. 7D, in one example implementation, selection of a “Competitors” control in GUI 700c can cause another GUI 700d to be presented to a user including a listing 712 of competitors of Company ABC (e.g., as identified or determined using query module logic, such as organization competitors query (e.g., 392)). GUI 700d can include infographics (e.g., 714) and other result data indicating aspects of the competitors' relationships, including mappings of competitor locations, graphs representing market share, market performance, stock share prices, etc., news feeds relating to one or more of the competitors identified in competitor listing 712, among other examples. Further, tools (e.g., 715a-c) can be provided for selecting particular competitors returned in the competitor listing. Selecting competitors can allow users to be presented with organization, product, and other market information for the selected competitor from one or more instances of models included in the global market model.

In another example, a GUI 700e, represented in the screenshot of FIG. 7E, shows another presentation (launched, for instance, from another GUI (e.g., GUIs 700a, 700c, 700d)) that includes a listing 718 of channel partners for Company ABC in a particular market product category. As in the example of GUI 700d of FIG. 7D, GUI 700e can allow a user to browse other channel partner organizations (and thereby information included in the model instances of these organizations), view related infographics (e.g., 720), and launch other views (e.g., via controls 722) to gain additional market intelligence from model instances included in the global market model relating to co-participants of Company ABC in a particular market product category (e.g., smart phones).

FIG. 7F includes a screenshot of an example GUI 700f presenting defined value chain roles for a particular organization (e.g., Company ABC). A listing 725 can be provided of the various value chain roles of the organization, as identified in one or more instances of models of the global market model. Further, GUI 700f (as with other example GUIs), in some implementations, can be further used to define or re-define value chain roles of the organization to be further included in subsequent instantiations of models relating to Company ABC. For instance, while Company ABC has been defined as a manufacturer in a set top boxes market product category, Company ABC may have recently jettisoned business units manufacturing set top boxes, thereby removing itself from that particular value chain role. Accordingly, an authorized user could utilize GUI 700f to modify the defined value chain roles for Company ABC to reflect this change (e.g., using controls 728a-b). Further, subsequent instantiations of models relating to Company ABC and/or the set top box market product category can reflect the change to Company ABC's defined value chain roles (e.g., that Company ABC is no longer a manufacturer of set top boxes).

Turning to FIG. 7G, an example GUI 700g is shown presenting information for a particular market product category (e.g., smart phones). Such a GUI 700g could be launched, for instance, in response to user interactions with one or more of the other example GUIs, such as the GUIs 700a-700f discussed above. GUI 700g can include an overview of the market product category, as well as access to additional views of attributes and global market model sub-models relating to the market product category (e.g., via controls 730). Such views can further provide authorized users with an interface for altering, supplementing, or otherwise modifying the global market model's inherent data (i.e., used in the instantiation of sub-models of the global market model), as described above. GUI 700g, in this example, can enable a user, for instance, to utilize global market model data and/or queries to view such information as value chain roles, customer segments, product features, etc. defined for the market product category.

FIG. 7H illustrates a screenshot of an example GUI 700h that can be provided to present and/or define product features for a particular market product category. Product GUI 700h can include such information as the product features defined for products in the market product category, as well as rules for defining acceptable values for the product features. Such rules can be utilized, for instance, by a data scrubber and data collection tools of a global market intelligence system to intelligently identify data either submitted by users, or collected (e.g., by a crawler) from digital resources available, for instance, on the Internet, and prepare the data for use in the global market model. Further, additional GUIs can be launched (e.g., from GUI 700h) allowing a user to access or define product feature values for particular products within the market product category. Such defined product features and product feature values can be used in the instantiation of corresponding models within the global market model, as well as (e.g., via queries) responding to market intelligence requests of the global market model.

The example screenshots of GUIs 700a-h are non-limiting examples of potential GUIs that can be presented from data and services (e.g., queries) provided from a global market model. In some instances, one or more of the GUIs (e.g., 700a-h) can be provided for rendering on a client device by the system hosting the global market model and corresponding query library. In other instances, one or more GUIs can be provided by outside applications and systems, as well as systems hosting or otherwise using organization-focused models interfacing with and utilizing the global market model. Such outside applications can receive raw results data from the host of the global market model and further process and render the results data to generate GUIs presenting global market model-based results as well as providing controls for users to interact with the global market model and systems hosting the global market model.

It should further be appreciated that the examples of FIGS. 1-7H, and corresponding discussions, include non-limiting examples presented merely for purposes of discussing certain principles and features germane to the present disclosure. Other, alternate configurations, steps, components, GUIs, and implementations can also be adopted without departing from the subject matter and principles of this disclosure.

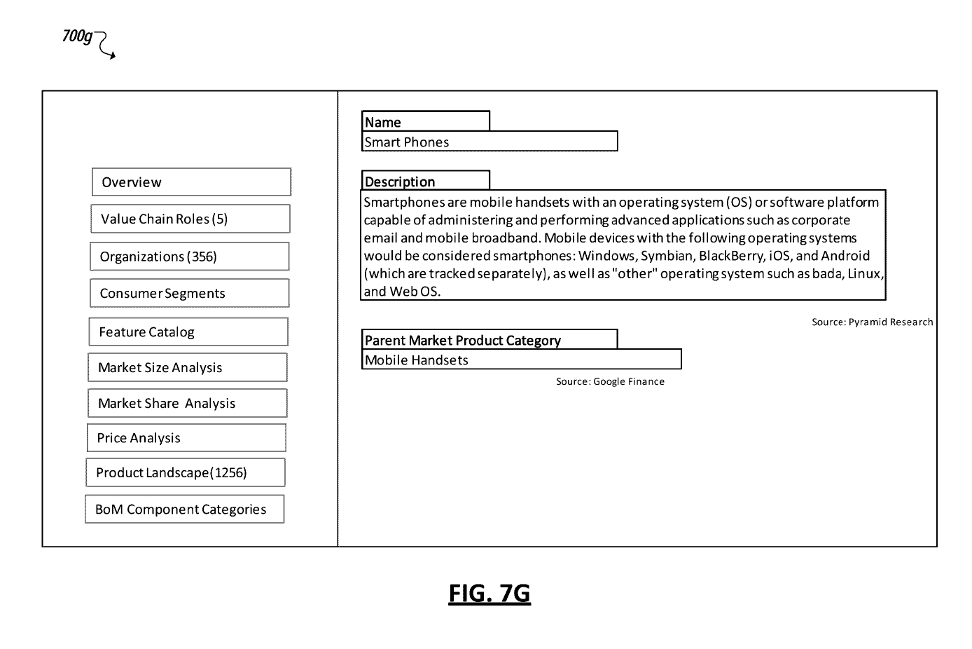

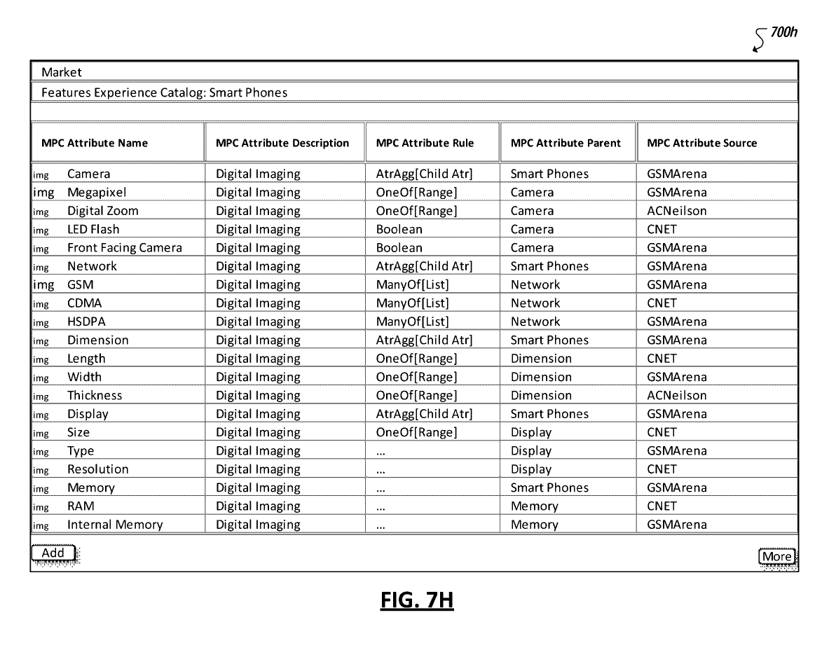

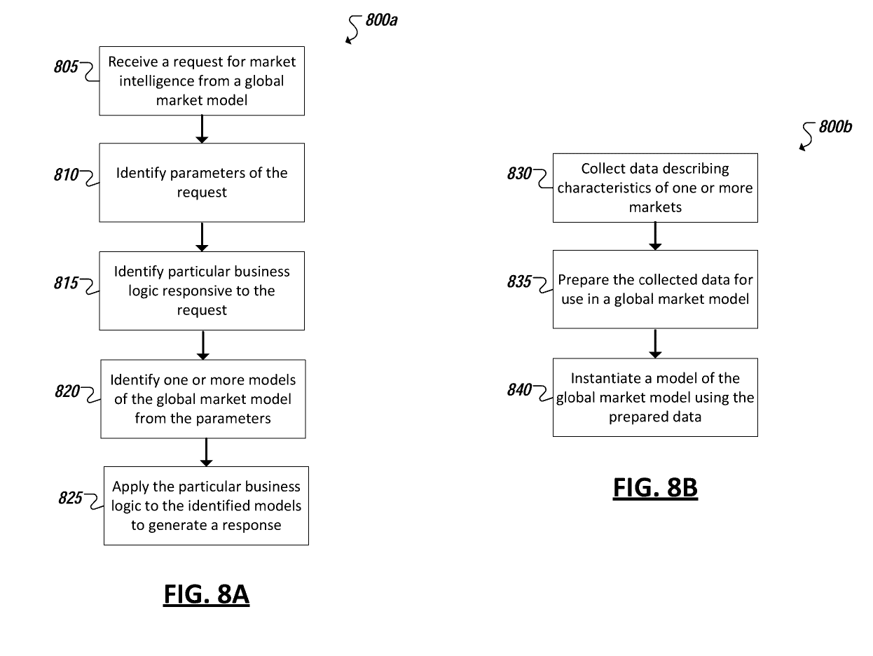

FIGS. 8A-8B include simplified flowcharts 800a-b illustrating example techniques for using global market models, such as those shown and described in the examples above. In the flowchart 800a of FIG. 8A, for instance, a request is received 805 for market intelligence obtainable from a global market model. The request can be received by a user and can embody, in some instances, a natural language question or request. In other instances, the request can be a machine-generated request from a software program or other computing system other than the system hosting the global market model. Parameters of the request can be identified 810, the parameters identifying particular characteristics of a market or market scenario relevant to the request. For instance, parameters can include the identification of an organization, product, market product category, value chain role, market region, or customer segment, among other characteristics of one or more markets. Indeed, in some examples, parameters can effectively point to particular instances of global market model model types for consideration in connection with the request. Parameters can also include filters, conditions, and other arguments for use in interrogating the relevant model type instances of the global market model.

Further, in some examples, the request can be parsed and categorized according to a meaning of the request, to identify 815 business logic (or corresponding query modules) adapted to perform an analysis of the global market model germane to the identified request. Further, a structured expression can be generated from the request that includes the identified parameters and is adapted for use as an input by the identified business logic. In connection with responding to the request, one or more instances of model types of the global market model can also be identified 820 based on the identified parameters (e.g., to identify those sub-models and instantiations thereof that are germane to the request). In some instances, identification 820 of the one or more model instances can be performed through the execution of the identified (at 815) business logic. In some examples, one or more of the model type instances can be identified 820 in parallel with or in connection with the identification 815 of the relevant business logic (i.e., with at least some of the model type instances being identified outside of the execution of the identified (at 815) business logic). The identified models can model one or more features of a market scenario related to the request, such as elements of a particular value chain, participants in the value chain, an identity of the value chain's market segment(s) (e.g., its market product category, region, etc.), products in the market, etc. The instantiated models can then be analyzed, for instance, using (e.g., at 825) the identified business logic (e.g., embodied in query modules or the global market model itself) to generate a response to the request for market intelligence. The response can then be returned to the requesting entity. For instance, response data can be rendered in a GUI presentation of a user device, returned as unrendered/unformatted data for rendering and processing by a requesting system (e.g., as pointers to respective instances of global market model model types identified by the executed business logic), returned for incorporation in an organization-focused model, among other examples and uses.

Turning to the flowchart 800b of FIG. 8B, data can be added to a global market model for use in instantiating, or generating, certain models of the global market model. Data can be collected 830 from a variety of sources, including web-based sources, the data describing one or more characteristics of markets in the global marketplace. The collection 830 of data can include identifying particular digital resources that include data describing aspects of the global marketplace, such as webpages, digital documents, files, data objects, and other data structures and resources. The collected data can be prepared 835 for use within the global market model. Preparing 835 the data can include, for instance, intelligently scanning, scrubbing, and validating data included in collected digital resources, for instance, to identify individual data values in the digital resources that correspond to particular model attributes of the global market model. Preparing 835 the data can further include formatting or otherwise scrubbing the identified values for compatibility with and consistency in the global market model. Using the collected and prepared data, one or more instances of one or more model types of the global market model can be instantiated 840 for use in connection with the answering of requests on the global market model for market intelligence, embodied, for instance, at least in part by the instantiated models containing the newly collected and prepared data.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. Systems and tools illustrated can similarly adopt alternate architectures, components, and modules to achieve similar results and functionality. For instance, in certain implementations, multitasking, parallel processing, and cloud-based solutions may be advantageous. Additionally, diverse user interface layouts and functionality can be supported. Other variations are within the scope of the following claims.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. A computer storage medium can be a non-transitory medium. Moreover, while a computer storage medium is not a propagated signal per se, a computer storage medium can be a source or destination of computer program instructions encoded in an artificially generated propagated signal. The computer storage medium can also be, or be included in, one or more separate physical components or media (e.g., multiple CDs, disks, or other storage devices), including a distributed software environment or cloud computing environment.

Networks, including core and access networks, including wireless access networks, can include one or more network elements. Network elements can encompass various types of routers, switches, gateways, bridges, load balancers, firewalls, servers, inline service nodes, proxies, processors, modules, or any other suitable device, component, element, or object operable to exchange information in a network environment. A network element may include appropriate processors, memory elements, hardware and/or software to support (or otherwise execute) the activities associated with using a processor for screen management functionalities, as outlined herein. Moreover, the network element may include any suitable components, modules, interfaces, or objects that facilitate the operations thereof. This may be inclusive of appropriate algorithms and communication protocols that allow for the effective exchange of data or information.

The operations described in this specification can be implemented as operations performed by a data processing apparatus on data stored on one or more computer-readable storage devices or received from other sources. The terms “data processing apparatus,” “processor,” “processing device,” and “computing device” can encompass all kinds of apparatus, devices, and machines for processing data, including by way of example a programmable processor, a computer, a system on a chip, or multiple ones, or combinations, of the foregoing. The apparatus can include general or special purpose logic circuitry, e.g., a central processing unit (CPU), a blade, an application specific integrated circuit (ASIC), or a field-programmable gate array (FPGA), among other suitable options. While some processors and computing devices have been described and/or illustrated as a single processor, multiple processors may be used according to the particular needs of the associated server. References to a single processor are meant to include multiple processors where applicable. Generally, the processor executes instructions and manipulates data to perform certain operations. An apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, module, (software) tools, (software) engines, or code) can be written in any form of programming language, including compiled or interpreted languages, declarative or procedural languages, and it can be deployed in any form, including as a standalone program or as a module, component, subroutine, object, or other unit suitable for use in a computing environment. For instance, a computer program may include computer-readable instructions, firmware, wired or programmed hardware, or any combination thereof on a tangible medium operable when executed to perform at least the processes and operations described herein. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Programs can be implemented as individual modules that implement the various features and functionality through various objects, methods, or other processes, or may instead include a number of sub-modules, third party services, components, libraries, and such, as appropriate. Conversely, the features and functionality of various components can be combined into single components as appropriate. In certain cases, programs and software systems may be implemented as a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, applications may represent web-based applications accessed and executed via a network (e.g., through the Internet). Further, one or more processes associated with a particular hosted application or service may be stored, referenced, or executed remotely. For example, a portion of a particular hosted application or service may be a web service associated with the application that is remotely called, while another portion of the hosted application may be an interface object or agent bundled for processing at a remote client. Moreover, any or all of the hosted applications and software service may be a child or sub-module of another software module or enterprise application (not illustrated) without departing from the scope of this disclosure. Still further, portions of a hosted application can be executed by a user working directly at a server hosting the application, as well as remotely at a client.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), tablet computer, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device, including remote devices, which are used by the user.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include any internal or external network, networks, sub-network, or combination thereof operable to facilitate communications between various computing components in a system. A network may communicate, for example, Internet Protocol (IP) packets, Frame Relay frames, Asynchronous Transfer Mode (ATM) cells, voice, video, data, and other suitable information between network addresses. The network may also include one or more local area networks (LANs), radio access networks (RANs), metropolitan area networks (MANs), wide area networks (WANs), all or a portion of the Internet, peer-to-peer networks (e.g., ad hoc peer-to-peer networks), and/or any other communication system or systems at one or more locations.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. A method comprising:
receiving a request for market intelligence of a global market model, wherein the global market model models a plurality of worldwide market segments and interactions between a respective plurality of business entities within each market segment and comprises a plurality of sub-models, each sub-model modeling respective aspects of a global marketplace and comprising an instance of one of a plurality of model types, wherein each model type comprises a respective structure and the plurality of model types comprise a market product category model type, a market region model type, an organization model type, a customer segment model type, value chain role model type, and a market segment model type;
interpreting, using at least one processor device, the request to identify parameters of the request, wherein interpreting the request comprises translating the request into a structured expression including an identification of at least one model type and at least one filter expression, wherein the parameters include the at least one model type and at least one filter expression;
selecting, from a set of business logic modules, a particular business logic module responsive to the request based on the identified parameters, wherein the set of business logic modules comprise a plurality of business logic modules and each business logic module in the set of business logic modules corresponds to a respective one of a plurality of categories of queries of the global market model and comprises machine-executable logic executable to parse the global market model and generate one or more responses corresponding to the category of queries of the global market model of the respective business logic module;
generating, using at least one processor device, an input for the particular business logic module from the at least one filter expression;
identifying, using at least one processor device, one or more sub-models of the global market model from the parameters of the request; and
executing the particular business logic module, using at least one processor device, to generate a response to the request from the identified one or more sub-models based on the input.

2. (canceled)

3. (canceled)

4. The method of claim 1, wherein:
the particular business logic module is embodied in at least one of a channel partners query module, a value chain suppliers query module, a product category competitors query module, and an organization competitors query module, the request causing the at least one of the channel partners query module, the value chain suppliers query module, the product category competitors query module, and the organization competitors query module to be invoked, the channel partners query module adapted to identify organizations that are channel partners to a particular organization in a particular market segment, the value chain suppliers query module adapted to identify organizations that are suppliers to a particular organization in a particular market product category, the product category competitors query module adapted to identify organizations that are competitors of one another in a particular market product category based on respective value chain roles of the organizations, and the organization competitors query module adapted to identify organizations that are competitors of a particular organization in a particular market segment.

5. The method of claim 1, wherein the particular business logic module is embodied in a competitor categories query module and the request causes the competitor categories query module to be invoked, the competitor categories query module adapted to identify product categories competing with a particular product category.

6. The method of claim 1, wherein:
the particular business logic module is embodied in at least one of a competitive landscape query module and a product competition query module, the request causes the at least one of the competitive landscape query module and the product competition query module to be invoked, the competitive landscape query module is adapted to identify products that compete with one another in a particular market segment, and the product competition query module is adapted to identify products that compete with a particular product in one or more particular market product categories.

7. The method of claim 1, wherein the particular business logic module is embodied in a market size forecast query module and the request causes the market size forecast query module to be invoked, the market size forecast query module adapted to return a market size forecast of a particular market segment corresponding to a particular time period.

8. The method of claim 1, wherein the particular business logic module is embodied in a demand change query module and the request causes the demand change query module to be invoked, the demand change query module adapted to identify organizations impacted by a particular change in demand within a value chain.

9. The method of claim 1, wherein:
the particular business logic module is embodied in at least one of a share-winning products query module, a share drivers ranking query module, and a share driver comparison query module, the request causes the at least one of the share-winning products query module, the share drivers ranking module, and the share driver comparison query module to be invoked, the share-winning products query module adapted to identify products within a particular market segment enjoying highest market share within the particular market segment, the share drivers ranking query module adapted to identify a rank-ordered listing of share drivers influencing market share within the particular market segment, and the share driver comparison query module is adapted to identify values of share drivers of competing products within the particular market segment.

10. The method of claim 1, wherein returning the response includes sending response data, via an application programming interface (API), to a client program hosted on a remote computing device.

11. The method of claim 1, wherein returning the response includes causing response data to be rendered in a graphical user interface (GUI) presentation on a client device.

12. (canceled)

13. The method of claim 1, wherein the request is a natural language query and identifying parameters of the request includes interpreting the natural language query.

14. The method of claim 1, wherein the set of business logic modules is utilized by a plurality of query modules, each query module adapted to return responses to a corresponding category of queries of the global market model and identifying the particular business logic module includes identifying a particular one of the plurality of query modules corresponding to the request.

15. The method of claim 14, wherein the particular query module is identified based on the identified parameters of the request.

16. An article comprising non-transitory, machine-readable media storing instructions operable to cause at least one processor to perform operations comprising:
receiving a request for market intelligence of a global market model, wherein the global market model models a plurality of worldwide market segments and interactions between a respective plurality of business entities within each market segment and comprises a plurality of sub-models, each sub-model modeling respective aspects of a global marketplace and comprising an instance of one of a plurality of model types, wherein each model type comprises a respective structure and the plurality of model types comprise a market product category model type, a market region model type, an organization model type, a customer segment model type, value chain role model type, and a market segment model type;
identifying parameters of the request, wherein interpreting the request comprises translating the request into a structured expression including an identification of at least one model type and at least one filter expression, wherein the parameters include the at least one model type and at least one filter expression;
selecting, from a set of business logic modules, a particular business logic module responsive to the request based on the identified parameters, wherein the set of business logic modules comprise a plurality of business logic modules and each business logic module in the set of business logic modules corresponds to a respective one of a plurality of categories of queries of the global market model and comprises machine-executable logic executable to parse the global market model and generate one or more responses corresponding to the category of queries of the global market model of the respective business logic module;
generating an input for the particular business logic module from the at least one filter expression;
identifying, through execution of the selected particular business logic module and the at least one model type, one or more sub-models of the global market model from the parameters of the request; and
executing the particular business logic module to apply business logic of the particular business logic module to the identified one or more models to generate a response to the request from the identified one or more sub-models based on the input.

17. A computer program product, encoded on a tangible, non-transitory, machine readable storage medium, the product comprising:
a global market software model modeling worldwide markets including a plurality of different market segments and interactions between a respective business entities within each market segment, the global market software model including:
one or more instances of a market product category model type each comprising a first defined structure comprising a sub-category sub-model, a product category sub-model, a category substitute sub-model, a category component sub-model and an accessory sub-model;
one or more instances of a market region model type each comprising a second defined structure;
one or more instances of an organization model type each comprising a third defined structure comprising a sub-organization sub-model, a product sub-model, a supply chain activity sub-model, an inventory node sub-model, a facility sub-model, and an accessory sub-model;
one or more instances of a customer segment model type each comprising a fourth defined structure comprising a sub-segment sub-model, a segment relation sub-model, and a demographics sub-model; and
one or more instances of a market segment model type each comprising a fifth defined structure comprising a market size forecast sub-model, a market share driver sub-model, a market share forecast sub-model, and a market share driver forecast sub-model; and
program code operable, when executed by a processor, to:
identify a set of instances of the model types of the global market software model responsive to a request based on attributes of the request;
select a particular business logic module in a plurality of business logic modules based on attributes of the request; and
cause the particular business logic module to be executed to consume the set of instances of the model types to generate a response to the request.

18. The product of claim 17, wherein the program code comprises the plurality of business logic modules including a channel partners query module comprising business logic adapted to provide responses to requests concerning the identification of channel partners within modeled value chains, a product category competitors query module comprising business logic adapted to generate responses to requests concerning the identification of competitors within modeled value chains of a product category, a value chain suppliers query module comprising business logic adapted to generate responses to requests concerning suppliers in modeled value chains, a demand change query module comprising business logic adapted to generate responses to requests concerning propagation within modeled value chains, a competitive landscape query module comprising business logic adapted to generate responses to requests concerning competing products in modeled product markets, a product competition query module comprising business logic adapted to generate responses to requests relating to features of competing products in modeled product markets, a market size forecast query module comprising business logic adapted to generate responses to requests concerning forecasted size of a market segment, a share drivers query module comprising business logic adapted to generate responses to requests concerning leading drivers of market share within a market segment, an organizations query module comprising business logic adapted to generate responses to requests concerning organizations modeled in the global market software model, a customer segments query module comprising business logic adapted to generate responses to requests concerning customer segments of a product category, a product categories query module comprising business logic adapted to generate responses to requests concerning product categories modeled in the global market software model, a market regions query module comprising business logic adapted to generate responses to requests concerning geographic market regions modeled in the global market software model, a people query module comprising business logic adapted to generate responses to requests concerning persons modeled in the global market software model, a forecasted segments query module comprising business logic adapted to generate responses identifying a listing of markets segments for a particular market product category involved in a particular market forecast of the market product category, an organization competitors query module comprising business logic adapted to generate responses to requests concerning competitors of an organization, a competitor categories query module comprising business logic adapted to generate responses to requests concerning competing product categories, a share-winning products query module comprising business logic adapted to generate responses to requests concerning market share of products within a market segment, a share drivers ranking query module comprising business logic adapted to generate responses to requests concerning the share drivers with highest influence on market share within a market segment, and a share driver comparison query module comprising business logic adapted to generate responses to requests concerning values of respective share drivers of products within a market segment.

19. The product of claim 17, wherein instances of the market product category model type each model a respective market product category and include:
an instance of the sub-category sub-model modeling subcategories of the respective market product category modeled by the corresponding instance of the market product category model; and
an instance of the product category feature sub-model modeling a set of product category features for the respective market product category modeled by the corresponding instance of the market product category model.

20. The product of claim 19, wherein the instances of the market product categories model type further include:
an instance of the category component sub-model modeling relationships of the respective market product category with one or more other market product categories identified as sub-components of the respective market product category;
an instance of the category substitute sub-model modeling relationships of the respective market product category with one or more other market product categories identified as potential substitute market product categories of the respective market product category; and
an instance of the accessory sub-model modeling relationships of the respective market product category with one or more other market product categories identified as accessories of the respective market product category.

21. The product of claim 17, wherein instances of the market region model type each model a respective geographic market region and includes at least one instance of the sub-region sub-model modeling a sub-region of the respective geographic market region modeled by the respective instance of the market region model type.

22. The product of claim 17, wherein instances of the organization model each model a respective market participant and include:
an instance of the product sub-model modeling products offered by the market participant modeled by the corresponding instance of the organization model type; and
an instance of the product group sub-model modeling groupings of products offered by the market participant modeled by the corresponding instance of the organization model type.

23. The product of claim 22, wherein instances of the organizations model type further include:
an instance of the supply chain activity sub-model modeling activities and lead times of activities performed by the market participant modeled by the corresponding instance of the organization model type;
an instance of the inventory node sub-model modeling inventory policy of the market participant modeled by the corresponding instance of the organization model type; and
an instance of the facility sub-model modeling facilities of the market participant modeled by the corresponding instance of the organization model type.

24. The product of claim 17, wherein instances of the market segment model type each model a respective market segment and include:
an instance of the market size forecast sub-model modeling forecasts of the size of the market segment modeled by the corresponding instance of the market segment model type;
an instance of the market share driver sub-model modeling market share drivers of the market segment modeled by the corresponding instance of the market segment model type;
an instance of the market share driver forecast sub-model modeling forecasts of relative importance of market share drivers of the market segment modeled by the corresponding instance of the market segment model type; and
an instance of the market share forecast sub-model modeling forecasts of market share of products within the market segment modeled by the corresponding instance of the market segments model type.

25. The product of claim 17, wherein the global market software model further includes the value chain role sub-model, each instance of the value chain role sub-model modeling respective roles that an organization can play within one or more market product categories.

26. A system comprising:
at least one processor device;
at least one memory element; and
a global market intelligence engine, adapted when executed by the at least one processor device to:
receive a request for market intelligence of a global market model, wherein the global market model models a plurality of worldwide market segments and interactions between a respective plurality of business entities within each market segment and comprises a plurality of sub-models, each sub-model modeling respective aspects of a global marketplace and comprising an instance of one of a plurality of model types, wherein each model type comprises a respective structure and the plurality of model types comprise a market product category model type, a market region model type, an organization model type, a customer segment model type, value chain role model type, and a market segment model type;
interpret the request to identify parameters of the request, wherein interpreting the request comprises translating the request into a structured expression including an identification of at least one model type and at least one filter expression, wherein the parameters include the at least one model type and at least one filter expression;
select, from a set of business logic modules, a particular business logic module responsive to the request based on the identified parameters, wherein the set of business logic modules comprise a plurality of business logic modules and each business logic module in the set of business logic modules corresponds to a respective one of a plurality of categories of queries of the global market model and comprises machine-executable logic executable to parse the global market model and generate one or more responses corresponding to the category of queries of the global market model of the respective business logic module;
generate an input for the particular business logic module from the at least one filter expression;
identify one or more models of the global market model from the parameters of the request, the global market model including a plurality of models, each model modeling aspects of a global marketplace; and
apply the particular business logic module to the identified one or more models to generate a response to the request based on the input.

27. The system of claim 26, further comprising a model generator adapted, when executed by the at least one processor device to:
collect data from one or more digital sources; and
prepare the collected data for use in generating instances of the one or more model types of the global market model.

28. (canceled)

29. The system of claim 26, wherein the set of business logic modules include at least two of a channel partners query module comprising business logic adapted to provide responses to requests concerning the identification of channel partners within modeled value chains, a product category competitors query module comprising business logic adapted to generate responses to requests concerning the identification of competitors within modeled value chains of a product category, a value chain suppliers query module comprising business logic adapted to generate responses to requests concerning suppliers in modeled value chains, a demand change query module comprising business logic adapted to generate responses to requests concerning propagation within modeled value chains, a competitive landscape query module comprising business logic adapted to generate responses to requests concerning competing products in modeled product markets, a product competition query module comprising business logic adapted to generate responses to requests relating to features of competing products in modeled product markets, a market size forecast query module comprising business logic adapted to generate responses to requests concerning forecasted size of a market segment, a share drivers query module comprising business logic adapted to generate responses to requests concerning leading drivers of market share within a market segment, an organizations query module comprising business logic adapted to generate responses to requests concerning organizations modeled in the global market software model, a customer segments query module comprising business logic adapted to generate responses to requests concerning customer segments of a product category, a product categories query module comprising business logic adapted to generate responses to requests concerning product categories modeled in the global market software model, a market regions query module comprising business logic adapted to generate responses to requests concerning geographic market regions modeled in the global market software model, a people query module comprising business logic adapted to generate responses to requests concerning persons modeled in the global market software model, a forecasted segments query module comprising business logic adapted to generate responses identifying a listing of markets segments for a particular market product category involved in a particular market forecast of the market product category, an organization competitors query module comprising business logic adapted to generate responses to requests concerning competitors of an organization, a competitor categories query module comprising business logic adapted to generate responses to requests concerning competing product categories, a share-winning products query module comprising business logic adapted to generate responses to requests concerning market share of products within a market segment, a share drivers ranking query module comprising business logic adapted to generate responses to requests concerning share drivers with highest influence on market share within a market segment, and a share driver comparison query module comprising business logic adapted to generate responses to requests concerning respective share drivers of products within a market segment.
